(19) United States
(12) Patent Application Publication
(10) Pub. No.: US 2006/0080642 A1
(43) Pub. Date: Apr. 13, 2006

(54) Program processing apparatus

(76) Inventors: Hajime Ogawa, Suita-shi (JP); Toshiyuki Sakata, Osaka-shi (JP); Taketo Heishi, Osaka-shi (JP)

Correspondence Address: WENDEROTH, LIND & PONACK, L.L.P., 2033 K STREET N. W., SUITE 800, WASHINGTON, DC, 20006-1021, US

(21) Appl. No.: 11/232,975

(22) Filed: Sep. 23, 2005

(30) Foreign Application Priority Data
Oct. 8, 2004 (JP) 2004-296288

(51) Int. Cl. G06F 9/44

(52) U.S. Cl. 717/126

(57) ABSTRACT

A program processing apparatus, which can check hint information as represented by a pragma so that a compiler may not create a wrong machine-language program, includes: a syntax analysis unit which analyzes a syntax of a program that includes hint information given by a user to the compiler, for generating analysis information; and an error check unit that checks whether or not the hint information in the program is logically contradictory.

### BACKGROUND OF THE INVENTION

(1) Field of the Invention

The present invention relates to a program processing apparatus which checks whether or not a source program written in a high-level language such as the C language is logically contradictory. The present invention particularly relates to a program processing apparatus which checks whether or not hint information, which is given to a compiler that converts a source program into a machine-language program, is logically contradictory.

(2) Description of the Related Art

Recently, development man-hour increases along with increases in the number of media processing application programs and the number of types thereof, application development using a high-level language is becoming a necessity even in the field of media processing. This leads to attempts to realize the media processing application using a high-level language. With this regard, the user expects a realization of a more precise tuning in the development using a high-level language. It is therefore necessary to control in detail optimization strategy performed by a compiler.

Two methods are provided for a method of controlling such optimization strategy: one is to directly give directives regarding a certain optimization to a compiler; and the other is to support optimization carried out by a compiler, by showing static information of the entire program to the compiler.

One of the methods for realizing the two control methods is to instruct a compiler using pragmas. A pragma is a description that is dependent on language processing system and that gives some information to the compiler.

The following describes an example of a pragma. FIG. 1 shows an example of a source program that includes a pragma that directly gives directives related to optimization. A pragma “#pragma_software_pipelining” is a pragma for giving a directive so that a software pipelining optimization is performed for a loop process which is written by the user immediately after the description of the pragma. The compiler performs the software pipelining optimization for the loop process, based on the directive given through the pragma. Software pipelining is a technique of simultaneously executing different iterations.

FIG. 2 shows an example of a source program which includes a pragma that shows static information of the entire program to the compiler. A pragma “#pragma_min_iteration=5” is a pragma by which the user assures that an iteration of loop process is executed at least for five times. The compiler, for example, judges whether or not the software pipelining optimization is feasible based on the pragma. If such optimization is feasible, the compiler performs it.

The pragma mentioned above is described in detail in Japanese Laid-Open Application No. 2004-38597.

In the two control methods described above, however, the user has to write a pragma in such a manner that the pragma does not logically contradict with the actual program. Therefore, it is required that the user analyzes plural modules in the program and writes a pragma in the program, however, the user may add a contradictory pragma by mistake due to the complexity of the relationship in which the modules are called. In such case, the compiler optimizes intermediate codes based on the directive indicated in the wrong pragma, which causes a problem that the compiler creates a wrong machine-language program.

Another problem is that a satisfactory optimization cannot be performed since the user cannot but passively add a pragma within the range analyzable by the user in order to avoid the generation of a wrong machine-language program.

### SUMMARY OF THE INVENTION

The first object of the present invention is to provide a program processing apparatus that can check hint information as represented by a pragma in order that the compiler does not create a wrong machine-language program.

The second object of the present invention is to provide a program processing apparatus that can check hint information so that the compiler can perform a satisfactory optimization even when the user positively gives, to the compiler, hint information as represented by a pragma.

In order to achieve the above objects, the program processing apparatus according to the present invention is a program processing apparatus, wherein the apparatus receives a program which includes hint information given by a user to a compiler, and checks if the hint information in the program is logically consistent. Preferably, the program processing apparatus includes: a syntax analysis unit operable to analyze a syntax of the program which includes the hint information, for generating analysis information; and a check unit operable to check if the hint information in the program is logically contradictory, based on the analysis information.

Thus, it is possible to check the hint information represented by a pragma by checking on logical consistency of the hint information, so that the compiler may not create a wrong machine-language program. It is also possible to check the hint information so that the compiler can perform a satisfactory optimization even when the user positively gives the hint information to the compiler. It should be noted that such hint information includes both of the following: hint information that directly gives, to the compiler, directives related to a certain optimization; and hint information that supports optimization performed by the compiler by presenting the compiler with static information of the whole program.

It is preferable that the hint information is static information which can be obtained through static analysis of the program, and the syntax analysis unit is operable to statically analyze the syntax of the program which includes the hint information, for generating the analysis information. The hint information is also the hint information is information related to the number of iterations of loop process, and the syntax analysis unit is operable to analyze the number of iterations for loop process included in the program which includes the hint information, for generating the analysis information which includes the number of iterations. For example, the hint information is information which specifies that an iteration of the loop process should be performed for a predetermined number of times or more, and the check unit is operable to check whether or not the iteration of the loop process specified in the hint information is performed for the predetermined number of times or more, based on the analysis information.

Thus, it is possible to check whether or not the hint information related to the number of iterations of loop process is logically contradictory.

It is more preferable that the hint information is information related to a placement of data, and the syntax analysis unit is operable to analyze the placement of data included in the program which includes the hint information, for generating the analysis information which includes the placement of data. For example, the hint information is information which specifies data and specifies that the data should be aligned with a predetermined value, the syntax analysis unit is operable to analyze an alignment value of the data included in the program which includes the hint information, for generating the analysis information which includes a result of the analysis, and the check unit is operable to check whether or not the alignment value of the data specified in the hint information indicates the predetermined value specified in the hint information, based on the analysis information.

Thus, it is possible to check whether or not the hint information related to a placement of data is logically contradictory.

More preferably, the hint information is information related to an area accessed by a pointer variable, and the syntax analysis unit is operable to analyze the area accessed by a pointer variable included in the program which includes the hint information, for generating the analysis information which includes a result of the analysis. The hint information is information which specifies a pointer variable and specifies that the area accessed by the pointer variable should not overlap with an area accessed by another pointer variable, the syntax analysis unit is operable to analyze whether or not the area accessed by the pointer variable included in the program which includes the hint information overlaps with the area accessed by the another pointer variable, for generating the analysis information which includes a result of the analysis, and the check unit is operable to check whether or not the area accessed by the pointer variable specified in the hint information overlaps with the area accessed by the another pointer variable, based on the analysis information. For example, the program is written in a language compliant with ISO/IEC 9899:1999-Programming Language C, and the hint information is a combination of the pointer variable and a “restrict” description.

Thus, it is possible to check whether or not the hint information related to pointer variables is logically contradictory.

It is also preferable that the hint information is information related to reading of data from a variable or writing of data into a variable, and the syntax analysis unit is operable to analyze reading of data from a variable included in the program which includes the hint information or writing of data into the variable, for generating the analysis information which includes a result of the analysis. For example, the hint information is information that specifies a variable and specifies, in a position located after a description of the hint information, that an access to the variable should start with writing of data, and the check unit is operable to check, based on the analysis information, whether or not the access to the variable specified in the hint information starts with writing of data, in a position located after the description of the hint information.

Thus, it is possible to check whether or not the hint information related to reading of data from a variable and writing of data into a variable is logically contradictory.

It is more preferable that the hint information is information related to a frequency at which a branch condition is satisfied, and the syntax analysis unit is operable to statically analyze the frequency at which a branch condition is satisfied, the branch condition being included in the program which includes the hint information, for generating the analysis information which includes a result of the analysis. For example, the hint information is information indicating that a probability for satisfying a branch condition is high, and the check unit is operable to check, based on the analysis information, whether or not the probability for satisfying a branch condition is high, the branch condition corresponding to the hint information.

Thus, it is possible to check whether or not the hint information, which is related to frequency at which a brunching condition is satisfied, is logically contradictory.

More preferably, the hint information is information which gives a directive on an optimization method applied by the compiler to optimize the program, and the check unit is operable to check whether or not the optimization method specified in the hint information is feasible, based on the analysis information. Also, the hint information is information which gives a directive on a loop unrolling optimization of loop process, the syntax analysis unit is operable to analyze the number of iterations for loop process included in the program which includes the hint information, and to generate the analysis information which includes the number of iterations, and the check unit is operable to check, based on the analysis information, whether or not the loop unrolling optimization can be performed on the loop process specified in the hint information.

Thus, it is possible to check whether or not the hint information that directly instructs the compiler to perform a loop unrolling optimization.

More preferably the hint information is information which gives a directive on a software pipelining optimization of loop process, the syntax analysis unit is operable to analyze the number of iterations for loop process included in the program which includes the hint information, and to generate the analysis information which includes a result of the analysis, and the check unit is operable to check, based on the analysis information, whether or not the software pipelining optimization can be performed on the loop process specified in the hint information.

Thus, it is possible to check whether or not the software pipelining optimization can be performed for the loop process specified in the hint information.

More preferably, the hint information is information which specifies plural data and gives a directive on an optimization of data access based on a generation of a pair instruction for the plural data, the syntax analysis unit is operable to analyze an alignment value of the data included in the program which includes the hint information, for generating the analysis information which includes a result of the analysis, and the check unit includes: a condition judgment unit operable to judge, based on the analysis information, whether or not an alignment value of the plural data specified in the hint information satisfies a condition that the alignment value indicates a size two or more times larger than a size of a data type of the plural data; and a pair instruction generation judgment unit operable to judge that the optimization of data access based on the generation of a pair instruction can be performed on the plural data specified in the hint information, in the case where the condition is satisfied.

Thus, it is possible to check whether or not the hint information that directly instructs the compiler to output a pair instruction is logically contradictory.

It is more preferable that the hint information is information which specifies a variable and gives a directive on an optimization of control processing to be performed on a cache memory.

Thus, it is possible to check whether or not the hint information related to a built-in function that gives a directive on control processing to be performed on a cache memory or the like is logically contradictory.

Another aspect of the program processing apparatus according to the present invention checks if hint information is logically consistent, the hint information being included in a program and being given to a compiler, the apparatus comprising a check unit operable (a) to receive, as inputs, a program which includes the hint information given by a user to the compiler, and analysis information that is a result of analyzing a syntax of the program, and (b) to check on logical consistency of the hint information in the program, based on the analysis information.

Thus, it is possible to check the hint information represented by a pragma by checking on logical consistency of the hint information based on the analysis information inputted from outside, so that the compiler may not create a wrong machine-language program. It should be noted that such hint information includes both of the following: hint information that directly gives, to the compiler, directives related to a certain optimization; and hint information that supports optimization performed by the compiler by presenting the compiler with static information of the whole program.

It should be noted that the present invention can be realized not only as the program processing apparatus that includes such characteristic units, but also as a program processing method that includes, as steps, these characteristic units included in the program processing apparatus. The present invention can be realized even as a program that causes a computer to function as the characteristic units. Such program is surely distributable via a storage medium such as a Compact Disc-Read Only Memory (CD-ROM) and a communication network such as the Internet.

According to the present invention, it is possible to provide the program processing apparatus that can check hint information as represented by a pragma, so that the compiler does not create a wrong machine-language program.

The present invention can also provide the program processing apparatus that can check hint information, so that satisfactory optimization can be performed even in the case where the user positively gives the hint information to the compiler. It is also possible to check the hint information so that the compiler can perform a satisfactory optimization even when the user positively gives the hint information to the compiler.

For further information about technical background to this application, the disclosure of Japanese Patent Application No. 2004-296288 filed on Oct. 8, 2004 including specification, drawings and claims is incorporated herein by reference in its entirety.

### BRIEF DESCRIPTION OF THE DRAWINGS

These and other objects, advantages and features of the invention will become apparent from the following description thereof taken in conjunction with the accompanying drawings that illustrate a specific embodiment of the invention. In the Drawings:

FIG. 1 shows an example of a source program that includes a pragma that directly gives directives related to optimization;

FIG. 2 shows an example of a source program that includes a pragma that presents a compiler with static information of the entire program;

FIG. 3 is a function block showing a structure of a program processing apparatus;

FIG. 4A shows an example of a program that includes a function “func1” and hint information relating to the number of iterations;

FIG. 4B shows an example of a program that includes a main function as well as functions “func2” and “func3”;

FIG. 5 is a flowchart showing processing executed by a syntax analysis unit;

FIG. 6 shows an example of a call flow graph;

FIG. 7 shows an example of analysis information;

FIG. 8 is a flowchart showing processing executed by an error check unit;

FIG. 9 shows an example of a check result;

FIG. 10A shows an example of a program that includes hint information related to pointer variables, and also includes functions “func1”, “func2” and “func3”;

FIG. 10B shows an example of a program that includes a main function;

FIG. 11 shows an example of the call flow graph created by the syntax analysis unit based on the programs shown in FIGS. 10A and 10B;

FIG. 12 shows an example of the analysis information created by the syntax analysis unit;

FIG. 13 is a flowchart showing processing executed by the error check unit;

FIG. 14 shows an example of a check result;

FIG. 15 shows an example of a program that includes hint information related to reading and writing of variables;

FIG. 16 shows an example of the call flow graph created by the syntax analysis unit based on the program shown in FIG. 15;

FIG. 17 shows an example of the analysis information created by the syntax analysis unit;

FIG. 18 is a flowchart showing processing executed by the error check unit;

FIG. 19 shows an example of a check result;

FIG. 20 shows an example of a program that includes hint information related to static frequency;

FIG. 21 shows an example of the call flow graph created by the syntax analysis unit based on the program shown in FIG. 20;

FIG. 22 shows an example of the analysis information created by the syntax analysis unit;

FIG. 23 is a flowchart showing the processing executed by the error check unit;

FIG. 24 shows an example of a check result;

FIG. 25 shows an example of a program that includes hint information related to loop unrolling;

FIG. 26 is a diagram showing the call flow graph created as a result of the processing described in S202 shown in FIG. 5;

FIG. 27 is a diagram showing the analysis information created as a result of the processing described in S203 and S204 shown in FIG. 5;

FIG. 28 is a flowchart showing the processing executed by the error check unit;

FIG. 29 shows an example of a program that includes hint information related to software pipelining;

FIG. 30 is a diagram showing the call flow graph created as a result of the processing described in S202 shown in FIG. 5;

FIG. 31 is a diagram showing the analysis information created as a result of the processing described in S203 and S204 shown in FIG. 5;

FIG. 32 is a flowchart showing processing executed by the error check unit;

FIG. 33 shows an example of a program that includes hint information related to pair instruction;

FIG. 34 is a diagram showing the call flow graph created as a result of the processing described in S202 shown in FIG. 5;

FIG. 35 is a diagram showing the analysis information created as a result of the processing described in S203 and S204 shown in FIG. 5;

FIG. 36 is a flowchart showing processing executed by the error check unit;

FIG. 37 shows an example of a program that includes hint information of built-in function that gives a directive on a control on a cache memory or the like;

FIG. 38 is a diagram showing the call flow graph created as a result of the processing described in S202 shown in FIG. 5;

FIG. 39 is a diagram showing the analysis information created as a result of the processing described in S203 and S204 shown in FIG. 5;

FIG. 40 is a flowchart showing processing executed by the error check unit;

FIG. 41 shows an example of a check result;

FIG. 42 shows an example of a program;

FIG. 43 shows an example of a check result indicating error information of hint information;

FIG. 44 shows an example of a check result that includes correction information;

FIG. 45 shows an example of a program;

FIG. 46 shows an example of the check result that includes correction information;

FIG. 47 shows an example of the check result that includes correction information of compile option;

FIG. 48 shows an example of a program;

FIG. 49 shows an example of the check result that includes uncertainty information indicating that it is impossible to judge whether or not a pragma is wrong;

FIG. 50 shows an example of the check result that includes warning information indicating that a pragma is possibly wrong;

FIG. 51 is a function block diagram showing another structure of the program processing apparatus;

FIG. 52 shows an example of a program; and

FIG. 53 shows an example of analysis information.

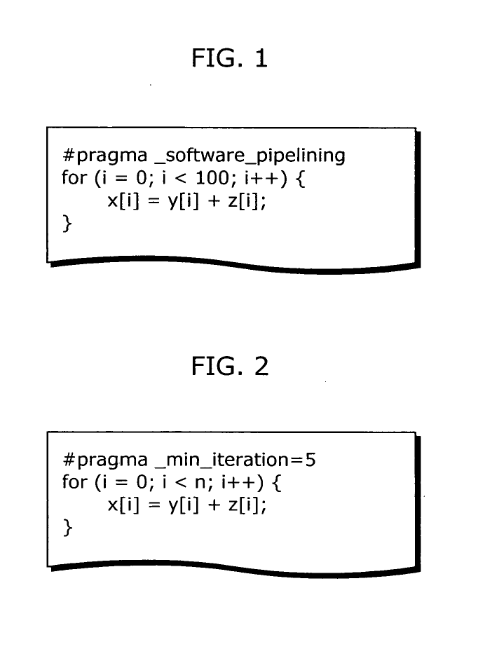

### DESCRIPTION OF THE PREFERRED EMBODIMENT(S)

The following describes a program processing apparatus according to the present embodiments, with reference to the diagrams.

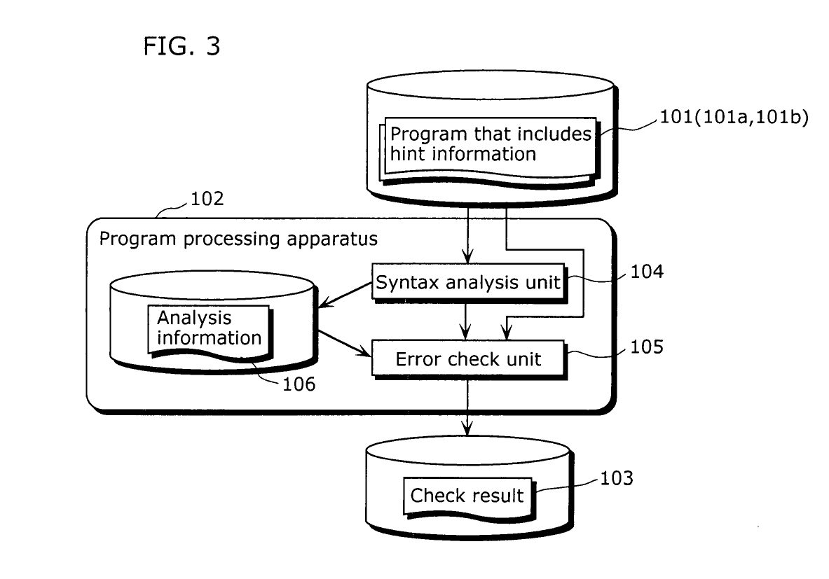

FIG. 3 is a function block diagram showing a structure of the program processing apparatus. A program processing apparatus 102 receives a program 101 which is written in a high-level language and includes hint information represented by a pragma, and judges on logical consistency of the hint information within the program 101. Such program processing apparatus 102 includes a syntax analysis unit 104 and an error check unit 105.

The syntax analysis unit 104 is a processing unit which receives the program 101 (also referred to as “programs 101a and 101b” in the case where the program 101 consists of plural files), performs, on the program 101, a normal syntax analysis applied by a general compiler, and outputs a result of the analysis as analysis information 106.

The error check unit 105 is a processing unit which checks if the hint information is logically consistent based on the program 101 and the analysis information 106, and outputs a check result 103.

Note that the processing executed by the syntax analysis unit 104 and the error check unit 105 are differently described according to each embodiment. Therefore, the detail will be described in each embodiment.

### First Embodiment, Hint Information Related to Number of Iterations

The present embodiment describes the program processing apparatus that checks whether or not the hint information related to the numbers of iterations of loop process is logically contradictory. The followings are examples of such hint information.

(1) Hint information which specifies a maximum number of iterations with regard to one loop process.

(2) Hint information which specifies a minimum number of iterations with regard to one loop process.

(3) Hint information which specifies that the number of iterations with regard to one loop process is always an even number.

(4) Hint information which specifies that the number of iterations with regard to one loop process is always an odd number.

The processing executed by the program processing apparatus 102 for the program 101 that includes such hint information is described below.

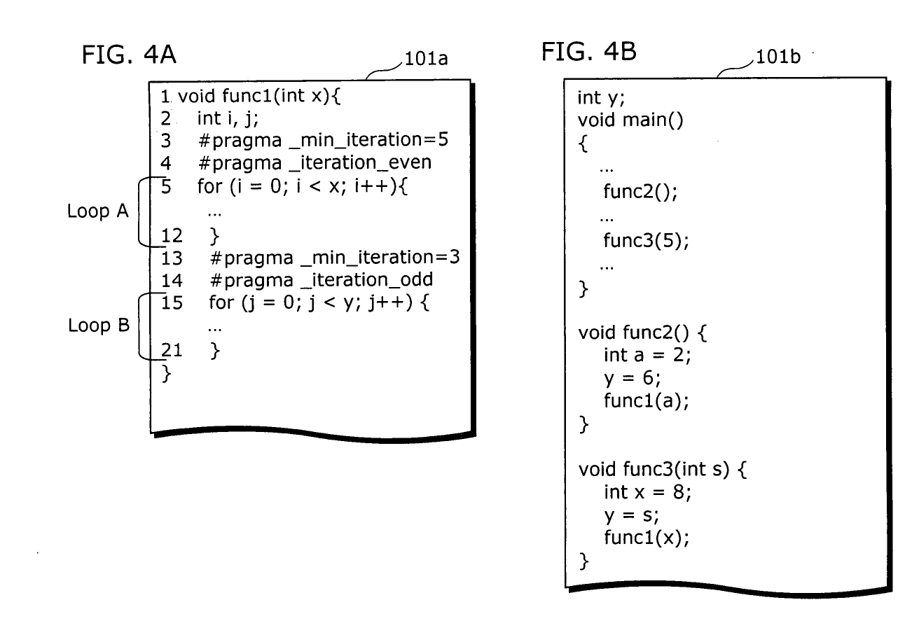

FIG. 4A shows an example of the program that includes a function “func1” and the hint information related to the numbers of iterations. FIG. 4B shows an example of the program that includes a main function as well as functions “func2” and “func3”.

The program 101a shown in FIG. 4A and the program 101b shown in FIG. 4B are to be linked after each of the programs is compiled.

A pragma “#pragma_min_iteration”, which is the second type of the hint information as presented above, indicates at least how many times the loop process (e.g. “for”, “while” and “do”) that follows immediately after the hint information should be iterated. In line 3 of the program 101a shown in FIG. 4A, a pragma “#pragma_min_iteration=5” is described. It is indicated by the user that the number of iterations for a loop A (from line 5 to line 12) is at least 5 times.

A pragma “#pragma_iteration_even”, which is the third type of the hint information as presented above, indicates that the number of iterations of the loop process (e.g. “for”, “while” and “do”) that follows immediately after the hint information is an even number. Such pragma is written in line 4 of the program 101a. Therefore, it is indicated by the user that the number of iterations for the loop A is always an even number.

A pragma “#pragma_iteration_odd”, which is the fourth type of the hint information as presented above, indicates that the number of iterations of the loop process (e.g. “for”, “while” and “do”) that follows immediately after the hint information is always an odd number. Such pragma is written in line 14 of the program 101a. Therefore, it is indicated by the user that the number of iterations for a loop B (from line 15 to line 21) is always an odd number.

Note that a pragma “#pragma_min_iteration=3” is written in line 13 of the program 101a. Therefore, it is indicated by the user that the number of iterations for the loop B is at least 3 times.

During the compilation carried out by the compiler, whether or not software pipelining is applicable is judged for the loop process based on the minimum number of iterations defined by the pragma “#pragma_min_iteration” for the loop process. In the case where software pipelining is applicable, optimization is performed so that software pipelining is performed on the loop process.

In the case where the minimum number of iterations defined by the pragma “#pragma_min_iteration” for the loop process is two or greater, and also, in the case where the pragma “#pragma_iteration_even” or the pragma “pragma_iteration_odd” is specified for the loop process, the compiler performs optimization so that loop unrolling is performed for the loop process. Loop unrolling is one of the loop process speeding-up methods for speeding up an execution speed within the loop process by simultaneously executing plural iterations. In the case where the number of iterations to be unrolled is two, process of optimization differs depending on whether the number is even or odd. In the case the number is even, unrolling may be performed without any particular processing, and in the case where the number is odd, iteration has to be executed one more time outside the loop process.

The following describes the processing executed by the syntax analysis unit 104 and the error check unit 105 in the case where the program 101a that includes the hint information as described above and the program 101b are inputted.

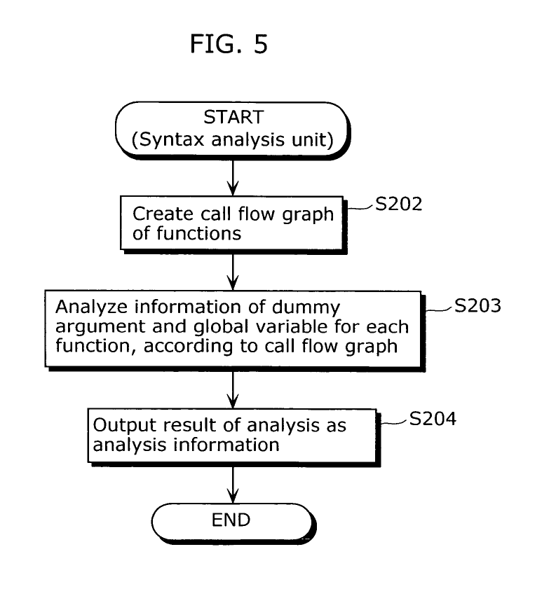

FIG. 5 is a flowchart showing the processing executed by the syntax analysis unit 104. The syntax analysis unit 104 analyzes the entire program 101 (i.e. programs 101a and 101b), and creates a call flow graph of functions (S202). This graph is similar to a normal call flow graph created by a compiler.

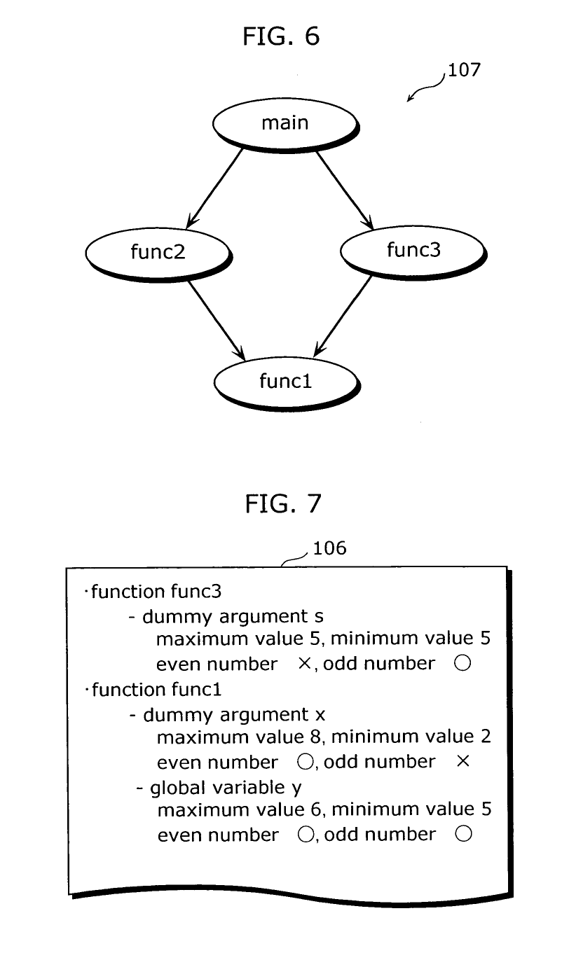

FIG. 6 shows an example of a call flow graph. The call flow graph 107 shown in FIG. 6 is created based on the programs 101a and 101b respectively shown in FIGS. 4A and 4B. The call flow graph 107 shows that a main function calls the functions “func2” and “func3”, the function “func2” calls the function “func1”, and the function “func3” calls the function “func1”. Thus, the call flow graph shows a call relationship between the functions by use of directions indicated by arrows.

As shown in FIG. 5, the syntax analysis unit 104 analyzes, based on the created call flow graph 107, a value of a dummy argument when a global variable or each function is called (S203). In the present embodiment, the syntax analysis unit 104 analyzes maximum value and minimum value of the value possibly indicated by a global value or a dummy argument, and also analyzes whether or not the global value or the dummy argument always indicates an even number or an odd number. Note that the syntax analysis 104 may analyze a local variable within a function.

The syntax analysis unit 104 outputs a result of the analysis as analysis information 106 (S204). FIG. 7 shows an example of the analysis information. The analysis information 106 in FIG. 7 shows a part of the analysis. The analysis information 106 shows that both of a maximum value and minimum value of a dummy argument “s” of the function “func3” are “5”, and the dummy argument may take an odd number, but not an even number. This is based on the following analysis: the call flow graph 107 shows that the function “func3” is called by the main function; and the program 101b shows that an actual argument of the function “func3” within the main function is “5” and the function “func3” is called only once. Thus, the analysis information 106 as described above can be obtained.

With regard to a global variable “y” in the function “func1”, the analysis information 106 shows that the maximum value is “6” and the minimum value is “5”, and the global variable “y” may possibly indicate either an odd or even value. This is based on the following analysis. The call flow graph 107 shows that the function “func1” is called by the functions “func2” and “func3”. In the function “func2”, “6” is substituted into the global variable “y”. In the function “func3”, a value of the dummy argument “s” is substituted into the global variable “y”. The call flow graph shows here that the function “func1” is called by the main function. Examining an actual argument of the function “func3” in the main function, it turns out to be “5”. Therefore, a value of the dummy argument “s” in the function “func3” is “538 . Namely, a value of the global variable “y” in the function “func3” is also “5”. Based on the above, a value possibly indicated by the global variable in the function “func3” is “5” or “6”. The analysis information 106 as described above can be therefore obtained. By performing the similar analysis, the analysis information 106 as shown in FIG. 7 can be obtained.

Next, the processing executed by the error check unit 105 will be described.

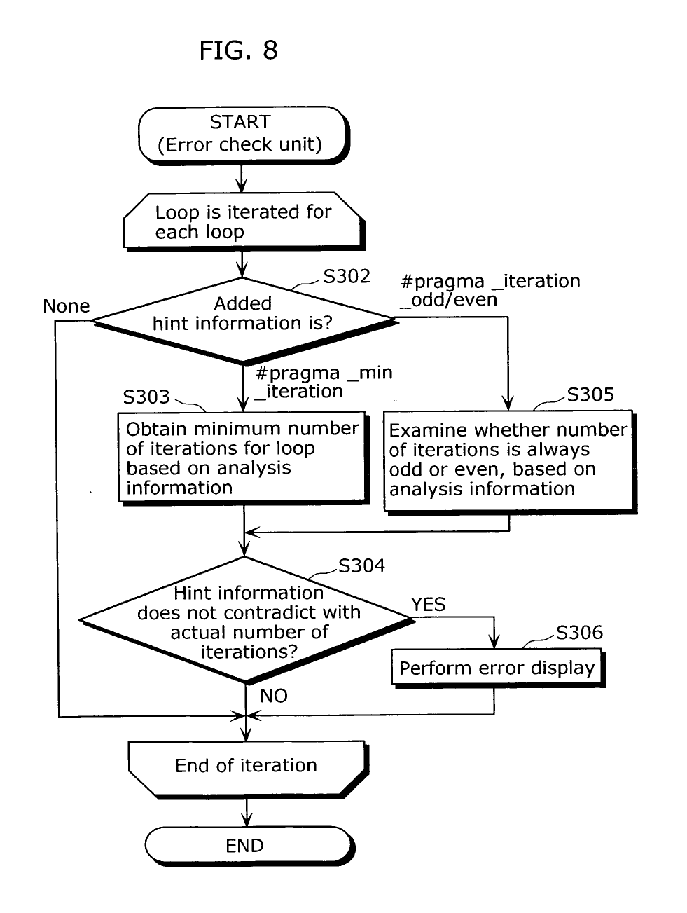

FIG. 8 is a flowchart showing the processing executed by the error check unit 105. The error check unit 105 repeats the following processing for each loop included in the programs 101a and 101b. Two loop process of loop A and loop B are included in the program 101a shown in FIG. 4A. The following processing shall be therefore executed for each of the loops A and B.

The error check unit 105 examines the hint information added to a current loop process (S302). For example, a pragma “#pragma_min_iteration=5” and a pragma “#pragma_iteration_even” are added to the loop A included in the program 101a.

In the case where the hint information is a pragma “#pragma_min_iteration” (“#pragma_min_iteration” in S302), the error check unit 105 also utilizes the analysis information 106 so as to obtain the minimum number of iterations for the current loop process (S303). For example, in the case of loop A, the analysis information 106 shows that a smallest value of a value of the dummy argument “x” defined by the number of iterations of the loop process is “2”. Therefore, it is required that the minimum number of iterations for the loop process A is “2”.

In the case where the hint information is a pragma “#pragma_iteration_even” (“#pragma_iteration_odd/even” in S302), the error check unit 105 examines whether the number of iterations for the current loop process always indicates an even number, using the analysis information 106 (S305). For example, in the case of the loop A, it is indicated that the value of the dummy argument “x” defined by the number of iterations of the loop process always indicates an even number, but not an odd number. Similarly, in the case where the hint information is a pragma “#pragma_iteration_odd” (“#pragma_iteration_odd/even” in S302), the error check unit 105 examines whether the number of iterations for the current loop process always indicates an odd number, using the analysis information 106 (S305).

Note that it is not always the case that either of the processing described in S303 and S305 is executed. In the case where plural pieces of hint information are added to the same loop process, both of the processing may be executed.

After the processing described in S303 and S305 is carried out, the error check unit 105 examines whether or not the hint information given to the loop process contradicts with the actual number of iterations for the loop process (S304). In the case where contradiction is found (YES in S304), the error check unit 105 displays a check result 103 as error information on a display unit that is not shown in FIG. 3 (S306).

For example, the pragma “#pragma min_iteration=5” in line 3 in the program 101a instructs that the minimum number of iterations for the loop A is 5 times, whereas in the processing described in S303, “2 times” is obtained as the minimum number of iterations for the loop A. The error check unit 105 therefore displays a check result 103 as error information. Similarly, the pragma “#pragma_iteration_odd” specified in line 14 of the program 101a instructs that the number of iterations for the loop B always indicates an odd number. It is, however, examined in the processing described in S305 that the value of the global variable “y” that defines the number of iterations for the loop B possibly indicates both an odd number and an even number. The error check unit 105 therefore displays a check result 103 as error information.

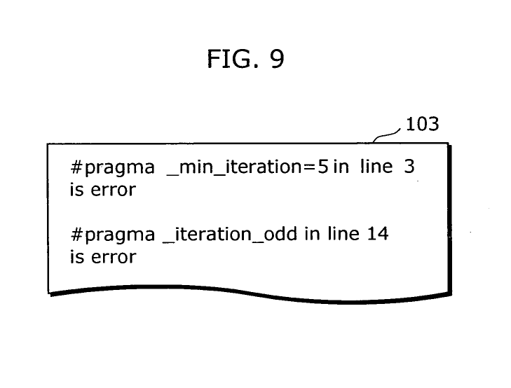

FIG. 9 shows an example of the check result. As described above, the result shows that, in the program 101a, both of the pragma “pragma_min_iteration=5” in line 3 and the pragma “#pragma_iteration_odd” in line 14 logically contradicts with the actual number of iterations.

After the display error is displayed as a check result 103 (S306), or in the case where the hint information given to the loop process does not contradict with the actual number of iterations for the loop process (NO in S304), the same processing (S302 to S306) as described above is performed for the next loop process. In the case where no hint information is added to the current loop process (“None” in S302), the error check unit 105 does not perform any processing for the current loop process, and performs the same processing (S302 to S306) as described above for the next loop process.

At the time when the above-mentioned processing (S302 to S306) is executed for every loop process included in the program 101, the processing to be executed by the error check unit 105 is terminated.

As described above, according to the present embodiment, it is possible to check whether or not the hint information related to the number of iterations for loop process is logically contradictory.

It should be noted that the present embodiment is described using pragmas being one type of hint information which are presented as the second through fourth types. A pragma “#pragma_max_iteration”, however, may be used as the first type of the hint information. This pragma indicates a maximum number of iterations for the loop process (e.g. “for”, “while” and “do”) that follows immediately after the hint information. For example, in the case where a description of the pragma “#pragma_max_iteration=10” is in the program, it is indicated by the user that the maximum number of iterations for the loop process that follows immediately after the pragma is, at maximum, 10 times. The error check unit 105 may check on logical contradiction for this pragma as well.

In the case where the error check unit 105 can judge logical contradiction of the hint information without the analysis information 106, the error check unit 105 may judge the contradiction without the analysis information 106. For example, in the case where the number of iterations of the loop process is defined by a constant instead of a variable, the error check unit 105 can obtain the minimum number of iterations for the loop process without referring to the analysis information 106.

### Second Embodiment, Hint Information Related to Pointer Variables

The present embodiment describes the program processing apparatus that checks whether or not the hint information related to pointer variable is logically contradictory. The followings are the examples of such hint information.

(1) Hint information which specifies an alignment value of data indicated by a pointer variable.

(2) Hint information which indicates that areas respectively indicated by a pointer variable do not overlap with each other.

The following describes the processing executed by the program processing apparatus 102 for the program 101 that includes such hint information as described above.

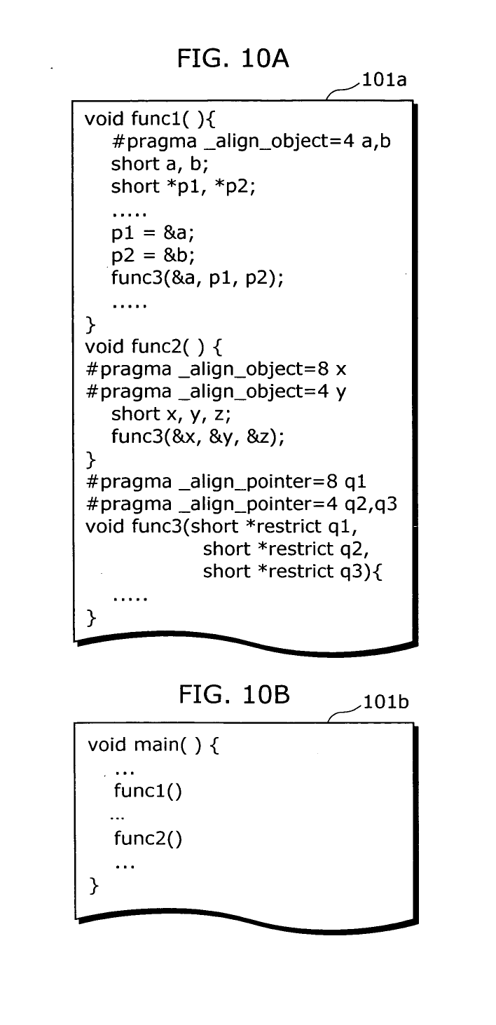

FIG. 10A shows an example of the program that includes hint information related to pointer variable as well as functions “func1”, “func2” and “func3”. FIG. 10B shows an example of the program that includes a main function.

The program 101a shown in FIG. 10A and the program 101b shown in FIG. 10B are to be linked after each of the programs is compiled.

A pragma “#pragma_align_pointer”, which is first type of the hint information presented above, indicates an alignment value, on the main memory, of the data indicated by the pointer variable specified in the pragma. For example, a description of the pragma “#pragma_align_pointer=8 q1” is located immediately before the function “func3” in the program 101a shown in FIG. 10A. It is a description by which the user indicates that the data specified by the pointer variable “q1” of the function “func3” is aligned in units of 8 bytes. Similarly, the description of the pragma “#pragma_align_pointer=4 q2,q3” is a description by which the user indicates that each of the data specified by the pointer variables “q2” and “q3” are respectively aligned in units of 4 bytes.

Note that the pragma “#pragma_align_object” included in the program 101a is a user's directive to align the data indicated immediately after the pragma should be aligned by the specified number of bytes. For example, the description of the pragma “#pragma_align_object=4 a,b” in the function “func1” is a directive to align the variables “a” and “b” on the main memory in units of 4 bytes. The variables “a” and “b” are short-type variables, each normally requiring 2 bytes. Therefore, in the present embodiment, in the case where the pragma “#pragma_align_object” is not written in the program, the variables shall be aligned in units of 2 bytes.

In this way, it is possible to align data and load or write at one time plural pieces of data from a memory by using a pair instruction, so that the compiler can perform such optimization. Thus, the number of accesses to the memory can be reduced and speed of processing can be increased.

A “restrict” description, which is the second type of the hint information as presented above, is introduced in C99 language (ISO/IEC 9899:1999-Programming Language C). Such “restrict” description indicates that areas in the main memory indicated by all the pointer variables specified in a scope of the “restrict” description do not overlap with each other. That is to say, the user indicates that the areas indicated by the pointer variables “q1”, “q2” and “q3” of the function “func3” do not overlap with each other. For example, in the case where the area indicated by the pointer “q1” does not overlap with the area indicated by the pointer “q2”, the compiler may perform optimization so that the order of executing an instruction to write data into the former area and an instruction to write data into the latter area may be switched.

The following describes the processing executed by the syntax analysis unit 104 and the error check unit 105 in the case where the program 101a that includes the hint information as described above and the program 101b are inputted.

The syntax analysis unit 104 executes the same processing as described in the flowchart shown in FIG. 5. However, a target to be analyzed is different from the target analyzed in the processing described in S203. Namely, the syntax analysis unit 104 analyzes an alignment value of the data indicated by a pointer argument in a function as well as an area indicated by the pointer argument, so as to analyze the possibility that the pointer indicates the same area as indicated by another pointer.

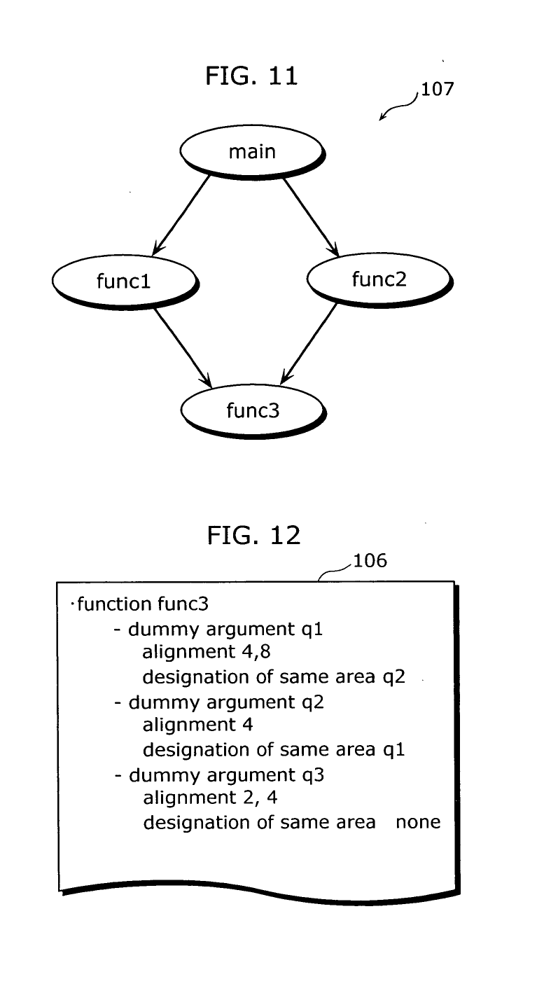

FIG. 11 shows an example of the call flow graph created by the syntax analysis unit 104 based on the programs 101a and 101b respectively shown in FIGS. 10A and 10B. According to the call flow graph 107, a main function calls functions “func1” and “func2”, each calling a function “func3”.

FIG. 12 shows an example of the analysis information 106 generated by the syntax analysis unit 104. In the processing described in S203 shown in FIG. 5, the syntax analysis unit 104 analyzes alignment values of a pointer argument and a global pointer variable when each function is called as well as the possibility that the same area is indicated by different pointer variables.

For example, a dummy argument “q1” of the function “func3” is considered here. The call flow graph 107 shows that the function “func3” is called by the functions “func1” and “func2”. The data indicated by an actual argument “&a” of the function “func3” within the function “func1” associated with the dummy argument “q1” is aligned in units of 4 bytes according to the pragma “#pragma_align_object=4 a,b”. Also, the data indicated by an actual argument “&x” of the function “func3” within the function “func2” associated with the dummy argument “q1” is aligned in units of 8 bytes according to the pragma “#pragma_align_object=8 x”. Therefore, an alignment value of the data indicated by the dummy argument “q1” of the function “func3” is 4 or 8.

The dummy arguments “q1” and “q2” of the function “func3” are respectively associated with the actual arguments “&a” and “p1” of the function “func3” within the function “func1”. The actual argument “&a” is substituted into “p1” immediately before the function “func3” is called within the function “func1”. Therefore, “p1” and “&a” indicate the same value. Consequently, the dummy argument “q2” is obtained as a pointer that may specify the same area as indicated by the dummy argument “q1”.

Similarly, analysis is performed also for the dummy arguments “q2” and “q3” in the same manner, and the analysis information 106 as shown in FIG. 12 can be obtained.

The following describes the processing executed by the error check unit 105.

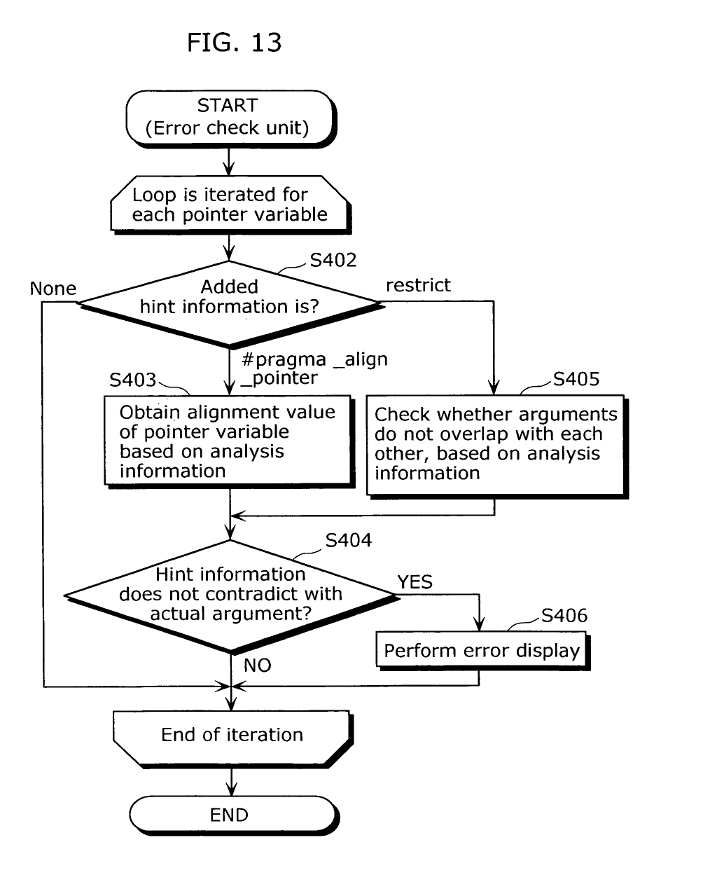

FIG. 13 is a flowchart showing the processing executed by the error check unit 105. The error check unit 105 repeats the following processing for each pointer variable included in the programs 101a and 101b. As shown in FIG. 10A, the program 101a includes the pointer variables “q1”, “q2” and “q3”.

The error check unit 105 examines the hint information that is added to a current pointer variable (S402). In the case where the hint information is a pragma “#pragma_align_pointer” (“#pragma_align_pointer” in S402), the error check unit 105 obtains an alignment value of the pointer variable using the analysis information 106 (S403). For example, in the case of the dummy argument “q1” of the function “func3”, 4 and 8 are obtained as the alignment value.

In the case where the information added to the current pointer variable is a “restrict” description (“restrict” in S402), the error check unit 105 checks whether or not the area indicated by the pointer variable does not overlap with the area indicated by another pointer variable (S405). For example, the description indicates that the area indicated by the dummy argument “q1” of the function “func3” overlaps with the area indicated by the dummy argument “q2” of the function “func3”.

Note that it is not always the case that either of the processing described in S403 and S405 is executed. In the case where plural pieces of hint information are added to the same pointer variable, both of the processing may be executed.

After the processing described in S403 and S405 is carried out, the error check unit 105 examines whether or not the hint information given to the pointer variable does not contradict with the actual information of the pointer variable (S404). In the case where contradiction is found (YES in S404), the error check unit 105 displays a check result 103 as error information on a display unit that is not shown in FIG. 3.

For example, as for the dummy argument “q1” of the function “func3”, two pieces of hint information, a pragma “#pragma_align_pointer=8 q1” and a “restrict” description, are added. The error check unit 105 firstly checks whether or not contradiction is found. The analysis information 106 shows that the alignment value of the dummy argument “q1” possibly indicates “4” or “8”. This does not correspond to the pragma “#pragma_align_pointer=8 q1” that is one of the hint information. The error check unit 105 therefore displays a check result 103 as error information. Then, the error check unit 105 checks whether contradiction is found in the “restrict” description. The analysis information 106 shows that there is a case where the dummy arguments “q1” and “q2” indicate the same area, which contradicts with the “restrict” description. The error check unit 105 therefore displays a check result 103 as error information (S406).

After the errors are displayed through the check result 103 (S406), or in the case where the hint information given to the pointer variable contradicts with the actual information of the pointer variable (NO in S404), the error check unit 105 performs the same processing (S402 to S406) as described above on the next pointer variable (e.g. dummy argument “q2” or “q3”). In the case where no hint information is added to the pointer variable (“None” in S402), the error check unit 105 does not perform any processing on the pointer variable, and performs, on the next pointer variable, the same processing (S402 to S406) as described above.

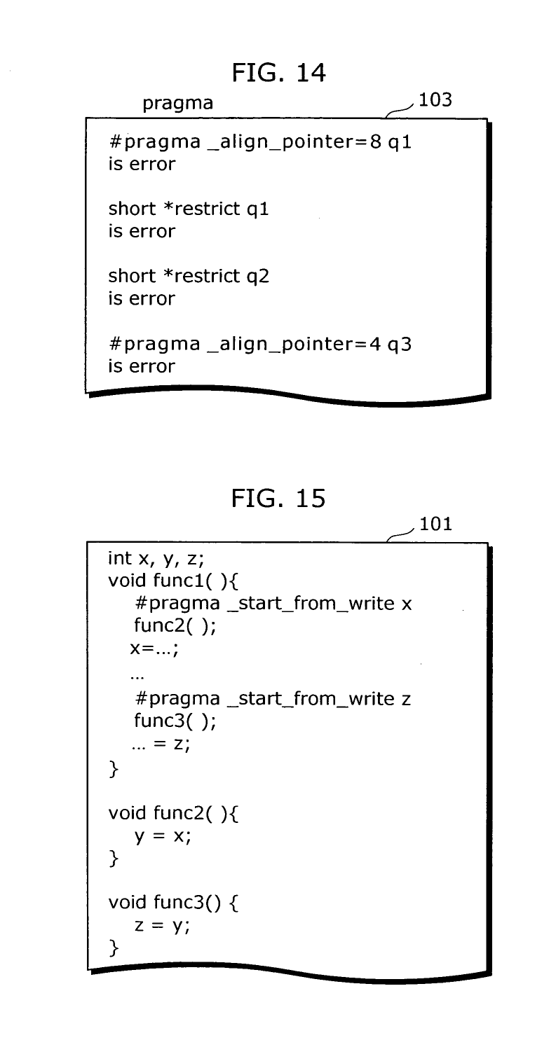

FIG. 14 is an example of the check result 103. As described above, the result shows that the pragma “#pragma_align_pointer=8 q1” and the “restrict” description “short*restrict q1” contradict the actual information of the pointer variable. Besides, the result also shows that the “restrict” description regarding the dummy argument “q2” contradicts with the pragma regarding the dummy argument “q3”.

At the time when the above processing (S402 to S406) is executed for all the pointer variables included in the program 101, the processing to be executed by the error check unit 105 is terminated.

As described above, according to the present embodiment, it is possible to check whether or not the hint information related to placement of data is logically contradictory.

It is also possible to check whether or not the hint information related to pointer variable is logically contradictory.

### Third Embodiment, Hint Information Related to Reading and Writing of Variables

The present embodiment describes the program processing apparatus that checks whether or not the hint information related to reading and writing of variables is logically contradictory. An example of such information is as indicated below:

(1) Hint information indicating that an access to a specified variable begins with writing of data, in a position located after the description of the hint information.

The following describes the processing executed by the program processing apparatus 102 for the program 101 that includes such information as described above.

FIG. 15 shows an example of a program that includes the hint information related to reading and writing of variables. The program 101 includes functions “func1”, “func2” and “func3”.

A pragma “#pragma_start_from_write”, which is the type of the hint information as described above, indicates that an access to the variable specified in the pragma starts with writing of data, in the position located after the description of the pragma. For example, the function “func1( )” in the program 101 includes a description of the pragma “#pragma_start_from_write x”. This is indicated by the user that an access to the variable “x” starts with the writing of data, in the position located after the description of the pragma.

In the case where a memory access occurs in a computer equipped with a cache memory, the compiler can perform optimization based on the pragma so that only an area is allocated for the memory access, and data transfer (pre-fetch processing) from a main memory to the cache memory is not operated. Thus, the time required for the memory access can be reduced.

The following describes the processing executed by the syntax analysis unit 104 and the error check unit 105 in the case where the program 101 that includes the hint information as described above is inputted.

The syntax analysis unit 104 executes the same processing as described in the flowchart shown in FIG. 5. However, a target to be analyzed is different from the target analyzed in the processing described in S203. That is to say that the syntax analysis unit 104 analyzes whether or not read from and write into a global variable is described for each of the functions in the program 101.

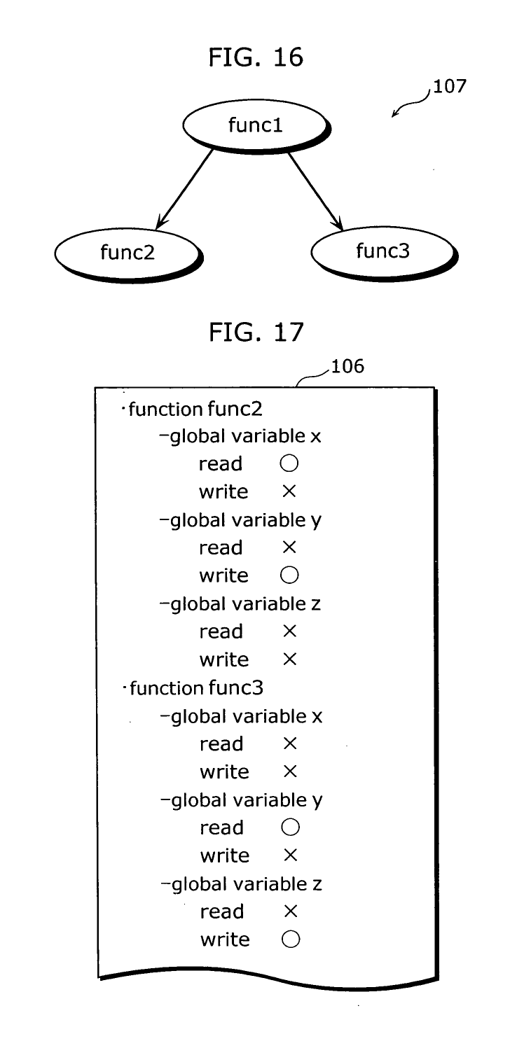

FIG. 16 shows an example of the call flow graph created by the syntax analysis unit 104 based on the program 101 shown in FIG. 15. According to the call flow graph 107, the function “func1” calls the functions “func2” and “func3”.

FIG. 17 shows an example of the analysis information 106 created by the syntax analysis unit 104. In the processing described in S203 shown in FIG. 5, the syntax analysis unit 104 checks on the presence of reading and writing for each global variable in each of the functions.

For example, in the function “func2”, writing of data into a global variable “y” and reading of data from a global variable “x” are executed, whereas in the function “func3”, writing of data into a global variable “z” and reading of data from the global variable “y” are executed. This results in the analysis information 106 shown in FIG. 17. Note that the syntax analysis unit 104 performs the same processing for the function “func1” and creates analysis information 106.

The following describes the processing executed by the error check unit 105.

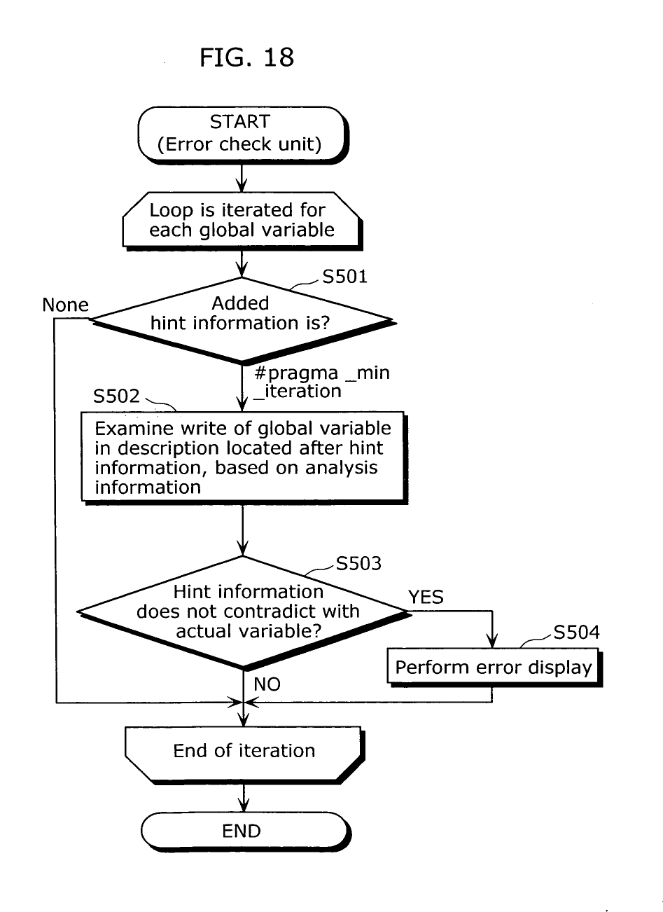

FIG. 18 is a flowchart showing the processing executed by the error check unit 105. The error check unit 105 repeats the following processing for each global variable included in the program 101. As shown in FIG. 15, the program 101 includes three global variables “x”, “y” and “z”.

The error check unit 105 examines the hint information added to a current global variable (S501). In the case where the hint information is a pragma “#pragma_start_from_write”, the error check unit 105 checks whether or not the description regarding writing of data into the current global variable is located after the description of the pragma, based on the analysis information 106 (S502). In the case where the pragma “#pragma_start_from_write” given to the global variable contradicts with the actual information of writing of data into the global variable (YES in S503), the error check unit 105 displays a check result 103 as error information onto a display unit that is not shown in FIG. 3 (S504).

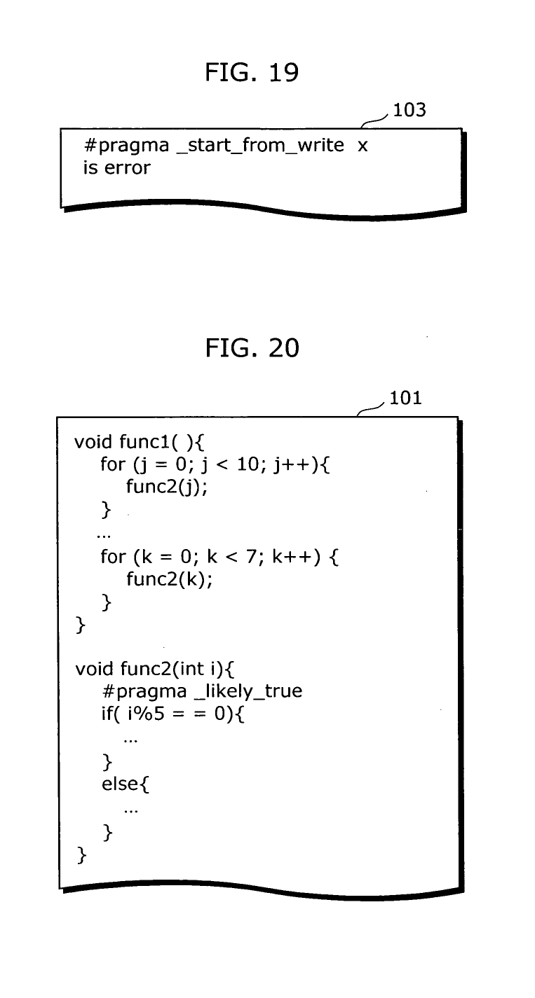

For example, as for the global variable “x”, the hint information of the pragma “#pragma_start_from_write” is inserted within the function “func1”. Therefore, in the processing described in S502, the error check unit 105 checks whether writing of data into the global variable “x” is indicated in a position located after the description of the pragma. In the program 101, a calling of the function “func2” is written immediately after the description of the pragma, whereas in the analysis information 106, reading of data from the global variable “x” is described in the function “func2”. Therefore, the pragma contradicts with the actual information of write into the global variable “x” (YES in S503). Therefore, the error check unit 105 displays the check result 103 as shown in FIG. 19, as error information (S504). That is to say that the error check unit 105 displays that the description of the pragma “#pragma_start_from_write x” is wrong.

Similarly, the error check unit 105 checks for the pragma “#pragma_start_from_write” that is related to the global variable “z” and is inserted into the function “func1”. The analysis information 106 shows that only reading of data from the global variable “z” is described in the function “func3” that is called in the position located immediately after the description of the pragma. Therefore, the pragma does not contradict with the actual information of write into the global variable “z”. The error check unit 105 therefore does not perform output error or the like.

As described above, according to the present embodiment, it is possible to check whether or not the hint information related to reading of data from a variable or writing of data into a variable is logically contradictory.

### Fourth Embodiment, Hint Information Related to Static Frequency

The present embodiment describes the program processing apparatus that checks whether or not the hint information related to static frequency is logically contradictory. The followings are the examples of such hint information.

(1) Hint information indicating a high frequency at which a branch condition is true.

(2) Hint information indicating a high frequency at which a branch condition is false.

The following describes the processing executed by the program processing apparatus 102 for the program 101 that includes the information as described above.

FIG. 20 shows an example of a program that includes the hint information related to static frequency. Functions “func1” and “func2” are included in the program 101.

A pragma “#pragma_likely_true”, which is the first type of the hint information as presented above, indicates that a frequency at which a conditional expression of if statement that follows immediately after the description of the pragma is true (i.e. conditional expression is true). In the program 101, the user indicates that there is a high frequency that the conditional expression using an if statement “i % 5==0” is true.

The compiler optimizes a placement of machine-language instructions based on the pragma so that an instruction sequence which is executed at the time when a conditional expression using an if statement is true is executed with higher priority than an instruction sequence executed at the time when the if statement is false, that is, an instruction sequence specified by an else statement. Thus, it is possible to decrease an amount of the time required for the execution of a machine-language program.

A pragma “#pragma_likely_false”, which is the second type of the hint information as presented above, indicates a high frequency that a condition expression of if statement that follows immediately after the description of the pragma is false (i.e. conditional expression is false).

The compiler optimizes a placement of machine-language instructions based on the pragma so that an instruction sequence executed at the time when a conditional expression using an if statement is false that is, an instruction sequence specified by an else statement, is executed with higher priority than an instruction sequence executed at the time when the if statement is true. Thus, it is possible to decrease an amount of the time required for the execution of a machine-language program.

The following describes the processing executed by the syntax analysis unit 104 and the error check unit 105 in the case where the program 101 that includes the hint information as described above is inputted.

The syntax analysis unit 104 executes the same processing as described in the flowchart shown in FIG. 5. However, a target to be analyzed is different from the target analyzed in the processing described in S203. That is to say that the syntax analysis unit 104 performs frequency analysis on a value of a dummy argument and a global variable in each function.

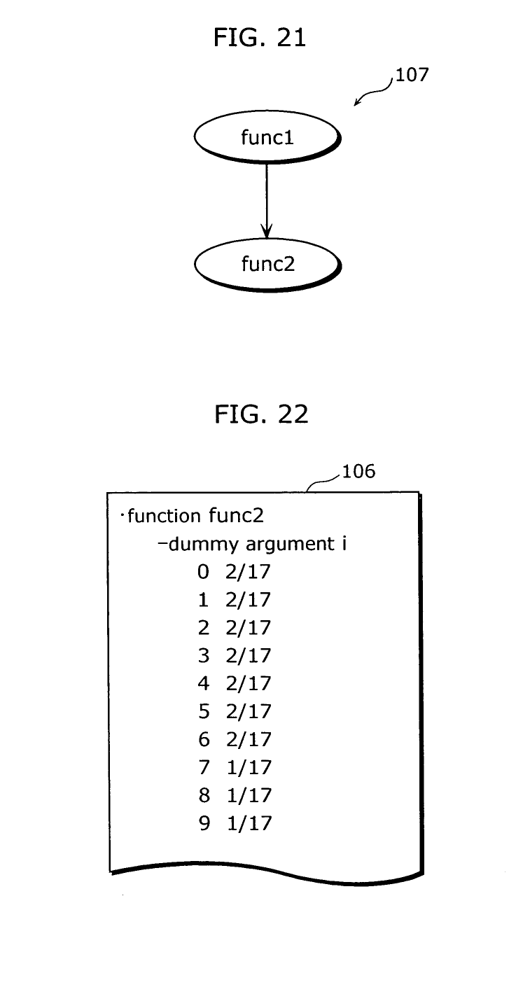

FIG. 21 shows an example of the call flow graph created by the syntax analysis unit 104 based on the program 101 shown in FIG. 20. According to the call flow graph 107, a function “func1” calls a function “func2”.

FIG. 22 shows an example of the analysis information 106 created by the syntax analysis unit 104. As described above, in the processing described in S203 shown in FIG. 5, the syntax analysis unit 104 performs frequency analysis on a value of each dummy argument and global variable in each function.

For example, in analyzing the frequency of a value of a dummy argument “i” in the function “func2”, there is a possibility that the function “func2” is called by the function “func1” for a total of 17 times, and the frequency of the value of the dummy argument “i” is indicated as the analysis information 106. For example, the number of times the dummy argument “i” indicates “0” is two. Therefore, it is shown that a probability at which the dummy argument “i” indicates “0” is 2 out of 17.

The following describes the processing executed by the error check unit 105.

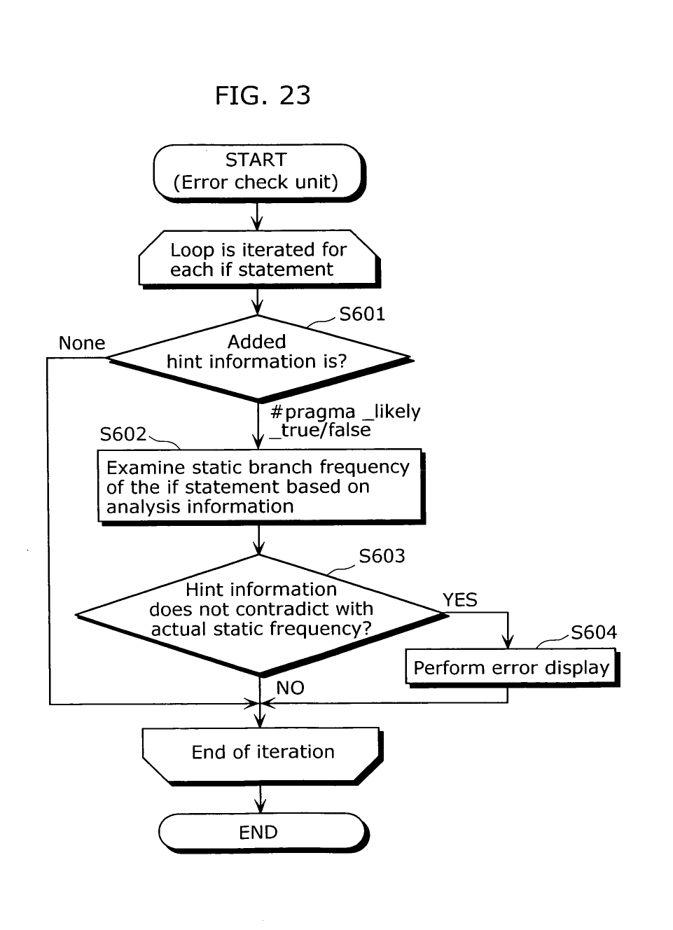

FIG. 23 is a flowchart showing the processing executed by the error check unit 105. The error check unit 105 repeats the following processing for each if statement. As shown in FIG. 20, the program 101 includes an if statement “if(i % 5==0)”.

The error check unit 105 examines the hint information added to a current if statement (S601). In the case where the hint information is a pragma “#pragma_likely_true” or a pragma “#pragma_likely_false” (“#pragma_likely_true/false” in S601”), the error check unit 105 examines, based on the analysis information 106, the frequency at which a conditional expression using the if statement is true or the frequency at which the conditional expression is false (S602). As a result, in the case where the hint information contradicts with the actual frequency (YES in S603), the error check unit 105 displays a check result 103 as error information on a display unit that is not shown in FIG. 3 (S604).

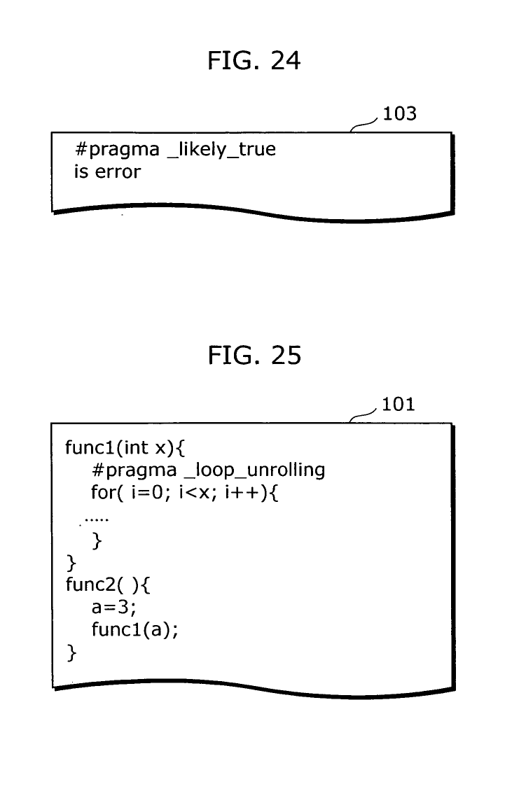

It is assumed that the pragma “#pragma_likely_true” is added to the if statement “if(i % 5==0)”, for example. The error check unit 105 therefore examines the frequency at which the conditional expression using the if statement is true, based on the analysis information 106 (S602). That is to say that when the dummy argument “i” indicates a multiple of “5”, the conditional expression “if(i % 5==0)” is true, and a probability at which the dummy argument “i” becomes a multiple of “5” is 4/17 (a sum of the probability of 2/17 where the dummy argument “i” indicates “0” and the probability of 2/17 where the dummy argument “i” indicates “5”). Therefore, the frequency at which this conditional expression is true is below the majority, and it is judged that the frequency at which the conditional expression is false is higher. Therefore, the error check unit 105 judges that the pragma “#pragma_likely_true” contradicts with the frequency at which the conditional expression “if (i % 5==0)” is true (YES in S603), and displays the check result 103 as shown in FIG. 24.

As described above, according to the present embodiment, it is possible to check whether or not the hint information related to static frequency (frequency at which a branch condition is satisfied) is logically contradictory.

### Fifth Embodiment, First Type of Hint Information for Specifying Optimization Method

The present embodiment describes the program processing apparatus that checks whether or not the hint information, which directly specifies an optimization method for the compiler, is logically contradictory. An example of such hint information is hint information that specifies loop unrolling.

The following describes the processing executed by the program processing apparatus 102 for the program 101 that includes such hint information.

FIG. 25 shows an example of a program that includes the hint information related to loop unrolling. Functions “func1” and “func2” are included in the program 101.

A pragma “#pragma_loop_unrolling”, which is the hint information as described above, that specifies loop unrolling, is a directive given by the user to the compiler to perform the loop unrolling optimization for the loop process (e.g. “for”, “while” and “do”) that follows immediately after the description of the pragma. For example, the pragma “#pragma_loop_unrolling” is written in the function “func1” of the program 101, and it is instructed by the user to perform loop unrolling on the for loop process that follows immediately after the description of the pragma. Here, the number of iterations for unrolling should be 2.

The compiler performs the loop unrolling optimization for a current for loop based on the pragma. Thus, it is possible to speed up the execution of the for loop process.

The following describes the processing executed by the syntax analysis unit 104 and the error check unit 105 in the case where the program 101 that includes the hint information as described above is inputted.

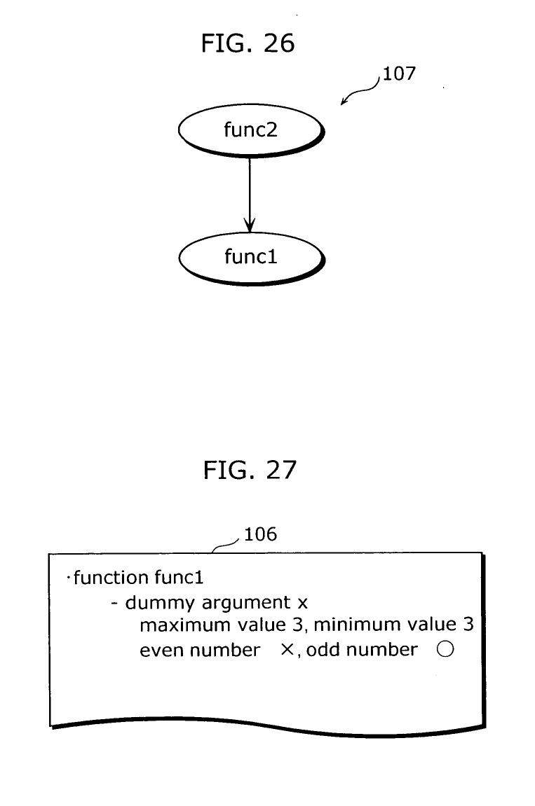

The syntax analysis information 104 executes the same processing as described in the flowchart shown in FIG. 5. FIG. 26 is a call flow graph created as a result of the processing described in S202 shown in FIG. 5. The call flow graph 107 shows that a function “func2” calls a function “func1”.

FIG. 27 is a diagram showing the analysis information created as a result of the processing described in S203 and S204 shown in FIG. 5. The analysis information 106 shows that both of a maximum value and a minimum value of a dummy argument “x” in the function “func1” indicates “3”, and that the dummy argument “x” always indicates an odd number, but not an even number. The processing of creating the analysis information 106 is as same as the processing described in the first embodiment, therefore, the detailed description will not be repeated here.

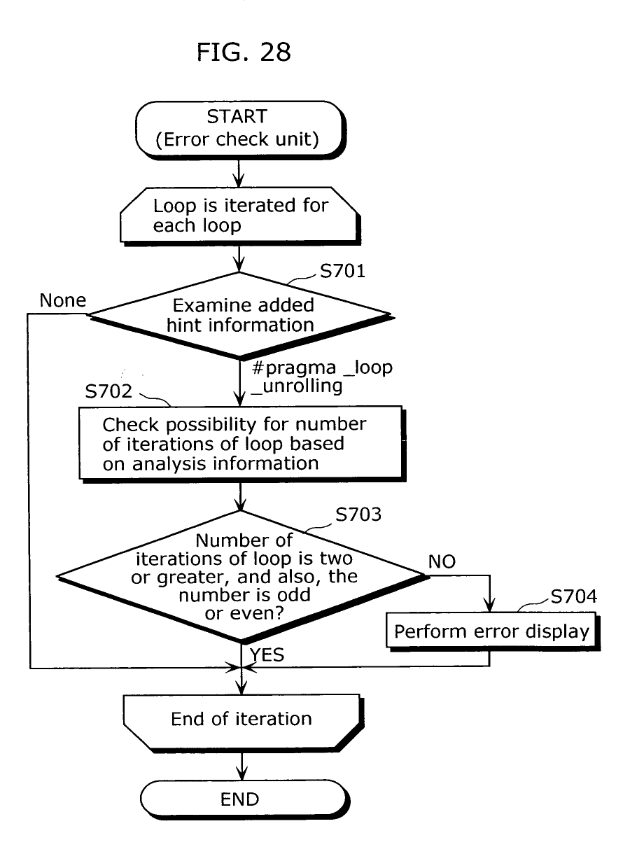

FIG. 28 is a flowchart showing the processing executed by the error check unit 105. The error check unit 105 repeats the following processing for each loop process included in the program 101.

The error check unit 105 examines the hint information added to a current loop process (S701). For example, it is assumed that a pragma “#pragma_loop_unrolling” is added to the for loop included in the program 101 shown in FIG. 25.

In the case where the hint information is a pragma “#pragma_loop_unrolling” (“#pragma_loop_unrolling” in S701), the error check unit 105 checks on a possible number of iterations of the current loop process, based on the analysis information 106 (S702). For example, it is assumed that the number of iterations of the for in the program 101 is defined by a value of the dummy argument “x”. However, the analysis information 106 shows that the number of iterations of the for loop is only three times and the number always indicates an odd number.

The error check unit 105 judges whether or not the number of iterations of the current for loop is two or greater, and also, whether the number always indicates an odd number or an even number (S703). In the case where these conditions are not satisfied (NO in S703), the compiler cannot perform the loop unrolling optimization for the loop process where the number of iterations for unrolling is two. Therefore, in such case, the error check unit 105 displays a check result 103 as error information on a display unit that is not shown in FIG. 3 (S704).

In the case where the conditions are satisfied (YES in S703), or after the error display is performed (S704), the error check unit 105 performs, for the next loop process, the same processing (S701 to S704) as described above. It should be noted that in the case of the for loop described above, the conditions are satisfied.

As described above, according to the present embodiment, it is possible to check whether or not the hint information that directly instructs the compiler to perform the loop unrolling optimization is logically contradictory.

### Sixth Embodiment, Second Type of Hint Information for Specifying Optimization Method

The present embodiment describes another program processing apparatus which checks whether or not the hint information which directly specifies an optimization method for the compiler is logically contradictory. An example of such hint information is hint information that specifies software pipelining.

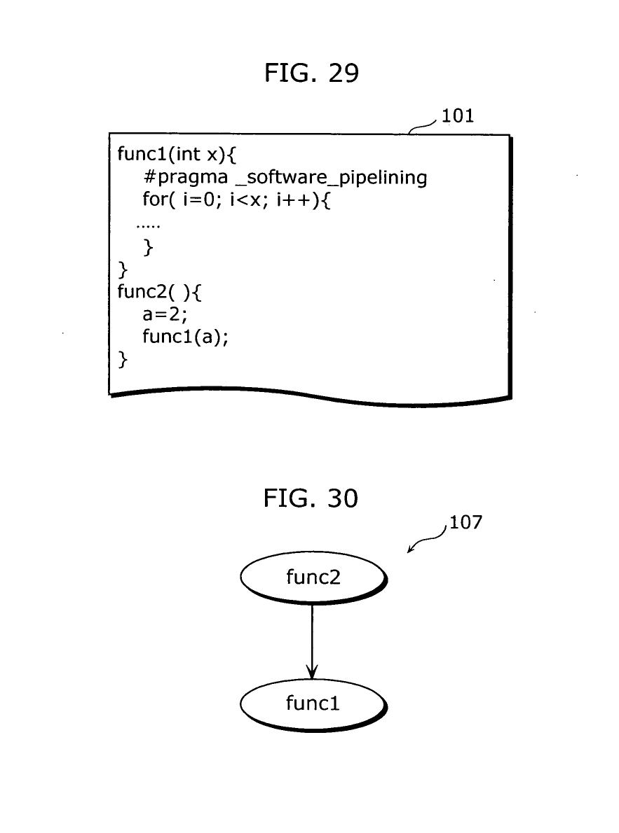

FIG. 29 shows an example of a program that includes hint information related to software pipelining. Functions “func1” and “func2” are included in the program 101.

A pragma “#pragma_software_pipelining”, which is the hint information that specifies software pipelining, is a directive given by the user to the compiler to perform the software pipelining optimization for the loop process (e.g. “for”, “while” and “do”) that is located immediately after the description of the pragma. For example, the pragma “#pragma_software_pipelining” is described in the function “func1” in the program 101, and it is instructed by the user to perform the software pipelining optimization for the for loop that is written immediately after the description of the pragma. It should be noted that software pipelining is a technique to simultaneously execute different iterations, therefore, the number of iterations of the loop process needs to be equal to or greater than the number of iterations executed at least at the same time, however, it is defined as 2 here.

The compiler performs optimization by means of software pipelining for the for loop based on the pragma. Thus, it is possible to speed up the execution of the for loop.

The following describes the processing executed by the syntax analysis unit 104 and the error check unit 105 in the case where the program 101 that includes such hint information as described above is inputted.

The syntax analysis unit 104 executes the same processing as described in the flowchart shown in FIG. 5. However, in the processing performed in S203, the difference is that only a minimum value of a dummy argument is analyzed when a global variable or each function is called.

FIG. 30 is a diagram showing a call flow graph created as a result of the processing performed in S202 shown in FIG. 5. The call flow graph 107 shows that a function “func1” calls a function “func2”.

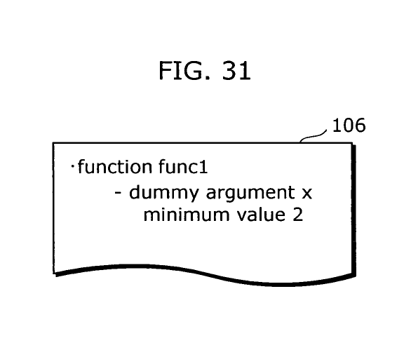

FIG. 31 shows the analysis information created as a result of the processing described in S203 and S204 shown in FIG. 5. The analysis information 106 indicates that a minimum value of a dummy argument“x” in the function “func1” is “2”. The processing of creating the analysis information 106 is as same as the processing described in the first embodiment, therefore, the detailed description will not be repeated here.

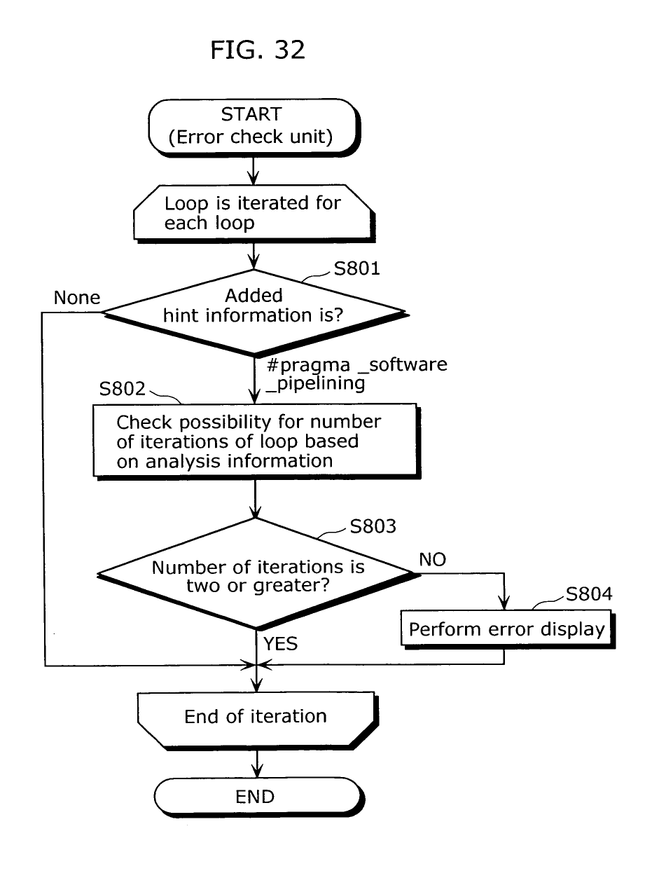

FIG. 32 is a flowchart showing the processing executed by the error check unit 105. The error check unit 105 repeats the following processing for each loop process included in the program 101.

The error check unit 105 examines the hint information added to a current loop process (S801). For example, it is assumed that a pragma “#pragma_software_pipelining” is added to the for loop included in the program 101 shown in FIG. 29.

In the case where the hint information is a pragma “#pragma_software_pipelining” (“#pragma_software_pipelining” in S801), the error check unit 105 checks on a possible number of iterations for the loop process based on the analysis information 106 (S802). For example, the number of iterations of the for loop in the program 101 is defined by a dummy argument “x”. Therefore, the analysis information 106 indicates that the number of iterations of the for loop is at least two.

The error check unit 105 judges whether or not the number of iterations of the current loop process is two or greater (S803). In the case where this condition is not satisfied (NO in S803), the compiler cannot perform the software pipelining optimization for the loop process. Therefore, in such case, the error check unit 105 displays a check result 103 as error information on a display unit that is not shown in FIG. 3 (S804).

In the case where the condition is satisfied (YES in S803), or after the error display is performed (S804), the same processing (S801 to S804) as described above is performed on the next loop process. It should be noted that in the case of the for loop as described above, the condition is satisfied.

As described above, according to the present embodiment, it is possible to check the hint information that directly instructs the compiler to perform the software pipelining optimization.

### Seventh Embodiment, Third Type of Hint Information for Specifying Optimization Method

The present embodiment describes another program processing apparatus that checks whether or not the hint information, which directly specifies an optimization method for the compiler, is logically contradictory. An example of such hint information is hint information that specifies an output of a pair instruction.

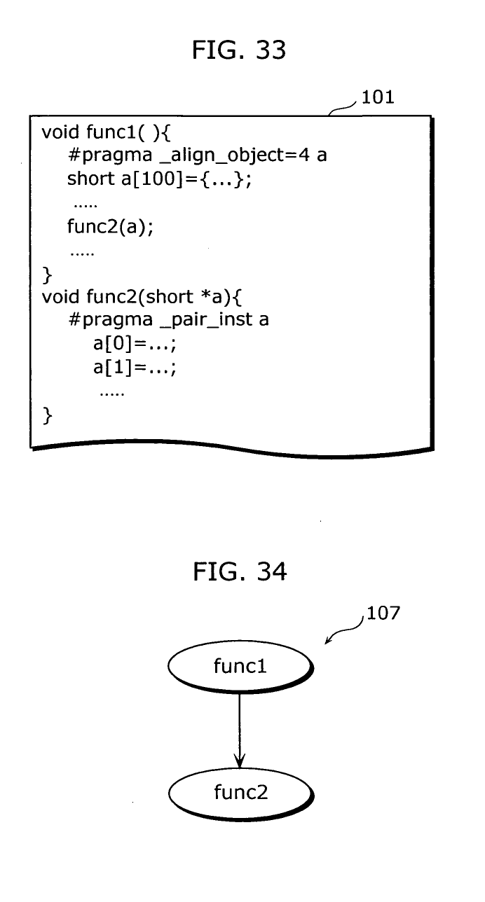

FIG. 33 shows an example of a program that includes the hint information related to pair instruction. Functions “func1” and “func2” are included in the program 101.

A pragma “#pragma_pair_inst p”, which is the hint information related to pair instruction, is a directive given by the user to the compiler to issue a pair instruction for loading or writing at one time the plural elements in the specified arrangement “p” from the memory, and perform optimization. For example, it is assumed that a pragma “#pragma_pair_inst a” is written in the function “func2” in the program 101, and the user gives a directive on the issuance of a pair instruction for an array “a”. Note that in order to issue a pair instruction, an alignment value of an element in the array “p” requires the number two or more times as large as the size of the normal type of the element in the array “p”.

The compiler performs optimization of issuing a pair instruction for the array “p” based on the pragma. Thus, it is possible to decrease the number of times for memory access, and thereby to speed up the processing.

The following describes the processing executed by the syntax analysis unit 104 and the error check unit 105 in the case where the program 101 that includes the hint information as described above is inputted.

The syntax analysis 104 executes the same processing as described in the flowchart shown in FIG. 5. However, in the processing performed in S203, the difference is that an alignment value of an element in the array specified by a dummy argument in a function is analyzed. Note that the method of analyzing an alignment value is as same as the one described in the second embodiment. Therefore, the detailed description is not repeated here.

FIG. 34 is a diagram showing a call flow graph created as a result of the processing described in S202 shown in FIG. 5. The call flow graph 107 shows that a function “func1” calls a function “func2”.

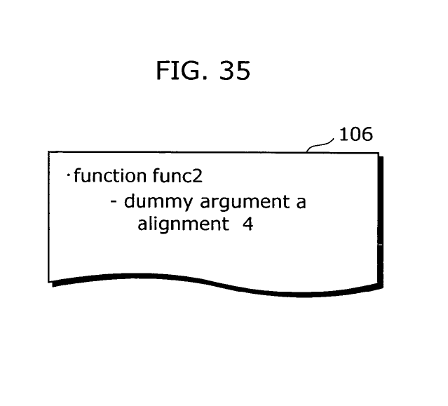

FIG. 35 shows analysis information created as a result of the processing described in S203 and S204 shown in FIG. 5. The analysis information 106 indicates that data in the area indicated by a dummy argument “a” in the function “func2”, that is, each element in the array “a”, is aligned in units of 4 bytes.

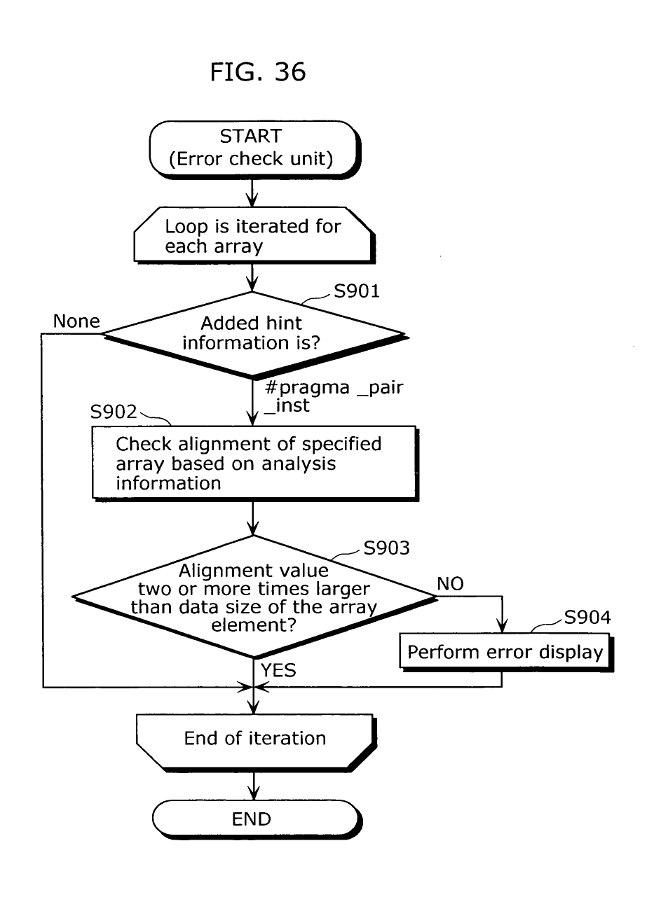

FIG. 36 is a flowchart showing the processing executed by the error check unit 105. The error check unit 105 repeats the following processing for each array included in the program 101.

The error check unit 105 examines the hint information added to a current array (S901). For example, it is assumed that a pragma “#pragma_pair_inst” is added to a pointer pointing a head element in the array “a” included in the program 101 shown in FIG. 33 (“#pragma_pair_inst a” is described in the program).

In the case where the hint information is a pragma “#pragma_pair_inst” (“#pragma_pair_inst” in S901), the error check unit 105 checks an alignment value of each element in the array based on the analysis information 106 (S902). Here, the analysis information 106 indicates that the alignment value of each element in the array “a” is “4”.

The error check unit 105 judges whether or not the alignment value of each array element that is checked is two or more times larger than the size of the normal type of the array element (S903). In the case where this condition is not satisfied (NO in S903), the compiler cannot perform optimization of issuing a pair instruction for the array. Therefore, in such case, the error check unit 105 displays a check result 103 as error information on a display unit that is not shown in FIG. 3 (S904).

In the case where the condition is satisfied (YES in S903), or after the error display is performed (S904), the same processing (S901 to S904) as described above is performed for the next array. Note that the element in the array “a” included in the program 101 is aligned in units of 4 bytes, and also, the type of the element is a “short” type. Since the data of “short” type requires 2 bytes, the array “a” satisfies the condition above.

As described above, according to the present embodiment, it is possible to check whether or not the hint information that directly instructs the compiler to output a pair instruction is logically contradictory.

### Eighth Embodiment, Fourth Type of Hint Information for Specifying Optimization Method

The present embodiment describes another program processing apparatus that checks whether or not the hint information which directly specifies an optimization method for the compiler is logically contradictory. An example of such hint information is hint information of built-in function that gives a directive on control processing to be performed on a cache memory, for example.

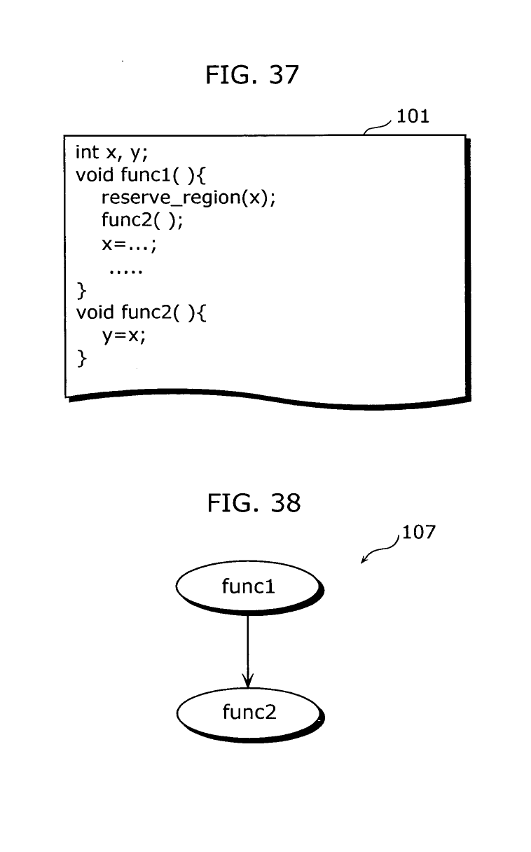

FIG. 37 shows an example of a program that includes the hint information of built-in function that gives a directive on the control processing to be performed on a cache memory or the like. Functions “func1” and “func2” are included in the program 101.

A built-in function “reserve_region”, which is the hint information that gives a directive on the control processing to be performed on a cache memory or the like, is a built-in function that executes only the processing in which only an area is allocated in the memory for storing a value of a variable specified by an actual argument of the built-in function, and a transfer (pre-fetch) of a value of the variable from the main memory to the cache memory is not performed. Thus, it is possible to decrease the time required for memory access. The reason why such processing can be performed is because the user assures, in the description located after the description of the built-in function “reserve_region”, that an access to the variable specified by the actual argument of the built-in function “reserve_region” starts with writing of data.

The following describes the processing executed by the syntax analysis unit 104 and the error check unit 105 in the case where the program 101 that includes the hint information as described above is inputted.

The syntax analysis unit 104 executes the same processing as described in the flowchart shown in FIG. 5. However, the processing described in S203, as in the case of the third embodiment, whether or not reading of data from a global variable and writing of data into a global variable exist in each function is analyzed.

FIG. 38 is a diagram showing a call flow graph created as a result of the processing described in S202 shown in FIG. 5. The call flow graph 107 indicates that a function “func1” calls a function “func2”.

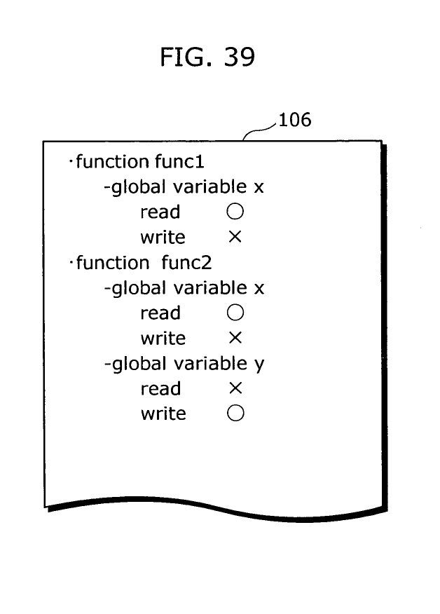

FIG. 39 shows the analysis information created as a result of the processing described in S203 and S204 shown in FIG. 5. The analysis information 106 shows, for example, that read from a global variable “x” and write into a global variable “y” are executed in the function “func2”.

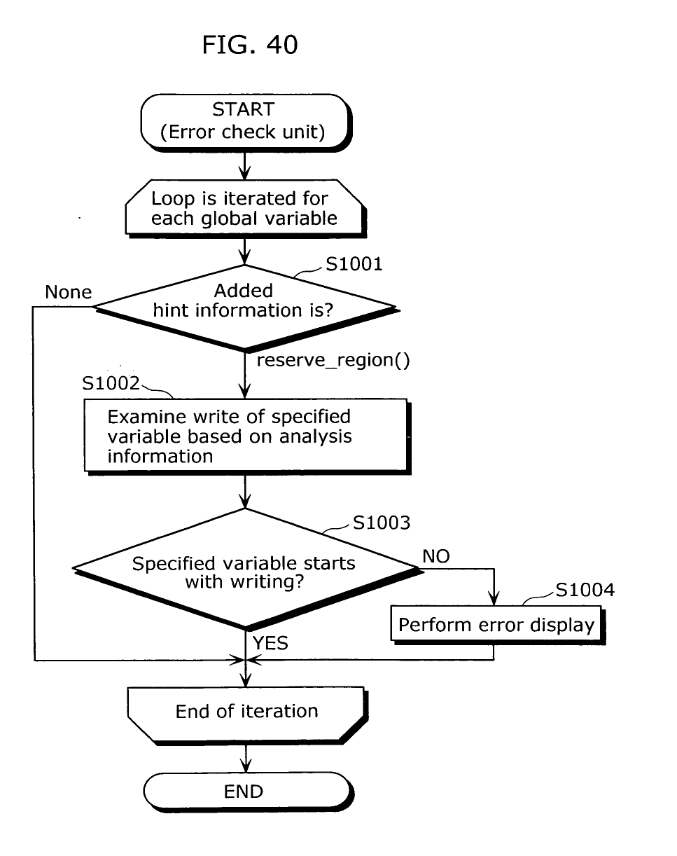

FIG. 40 is a flowchart showing the processing executed by the error check unit 105. The error check unit 105 repeats the following processing for each global variable included in the program 101.

The error check unit 105 examines the hint information added to a current global variable (S1001). In the case where the hint information is a built-in function “reserve_region” (“reserve_region ( )” in S1001), the error check unit 105 checks whether writing of data into a global variable is written in a position located after the description of the built-in function (S1002).

The error check unit 105 checks, for the current global variable, whether or not an access to the global variable starts with writing of data in the position located after the description of the built-in function (S1003). In the case where this condition is not satisfied (NO in S1003), the error check unit 105 displays a check result 103 as error information on a display unit that is not shown in FIG. 3 (S1004).

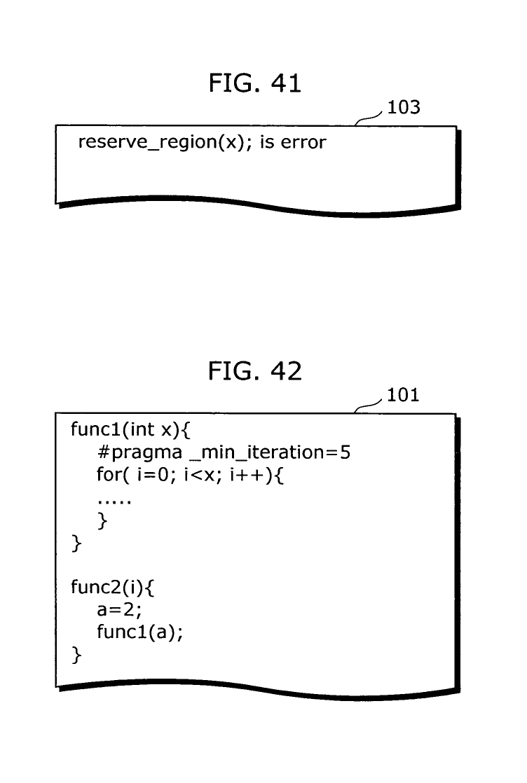

For example, with regard to a global variable “x”, it is assumed that the hint information of built-in function “reserve_region (x)” is added to the function “func1” in the program 101. Therefore, in the processing described in S1002, the error check unit 105 checks whether or not writing of data into the global variable “x” is written in the position located after the description of the built-in function. In the program 101, a call of the function “func2” is written immediately after the description of the built-in function, whereas in the analysis information 106, reading of data from the global variable “x” is described in the function “func2”, but not writing of data into the global variable “x”. Therefore, the access to the global variable “x” starts with reading of data from the global variable “x”, and thereby does not satisfy the condition (NO in S1003). Therefore, the error check unit 105 displays the check result 103 as shown in FIG. 41, as error information, on a display unit that is not shown in FIG. 3 (S1004).

In the case where the condition is satisfied (YES in S1003), or after the error display (S1004), the check unit 105 performs the same processing (S10Ol to S1004) as described above for the next global variable.

As described above, according to the present embodiment, it is possible to check whether or not the hint information of the built-in function that gives a directive on the control processing to be performed on a cache memory or the like is logically contradictory.

According to the first through eighth embodiments described above, it is possible to check the hint information represented as a pragma, so that the compiler may not create a wrong machine-language program. Thus, it is possible to check the hint information so that the compiler performs satisfactory optimization even in the case where the user positively gives the hint information represented as a pragma. Note that such hint information includes both of the following: hint information that directly gives, to the compiler, directives regarding a certain optimization; hint information for supporting the optimization carried out by the compiler, by presenting the compiler with static information of the entire program.

As described so far, the program processing apparatus according to the present invention is described based on the embodiments, however, the present invention is not limited to these embodiments.

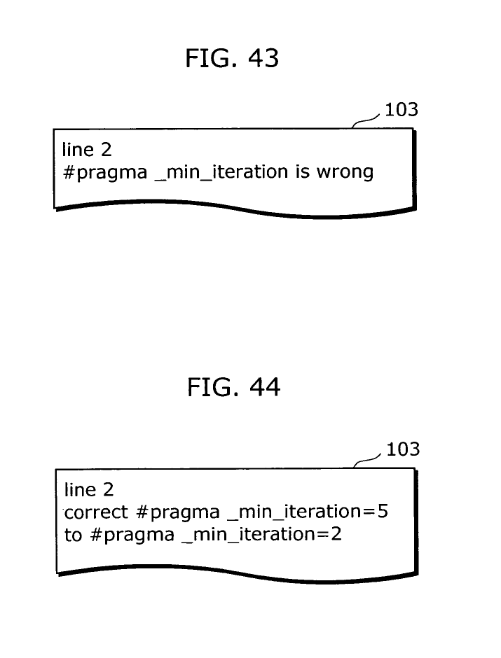

For example, in the case where the program 101 as shown in FIG. 42 is given, the error unit 105 may display a check result 103 that includes correction information, as shown in FIG. 44, instead of displaying the check result 103 indicating error information of the hint information, as shown in FIG. 43, which is the case of the embodiments described above. The check result 103 shown in FIG. 44 is an example of the check result 103 indicating correction information, and shows that the pragma “#pragma_min_iteration=5” in line 2 of the program 101 should be corrected to “#pragma_min_iteration=2”.

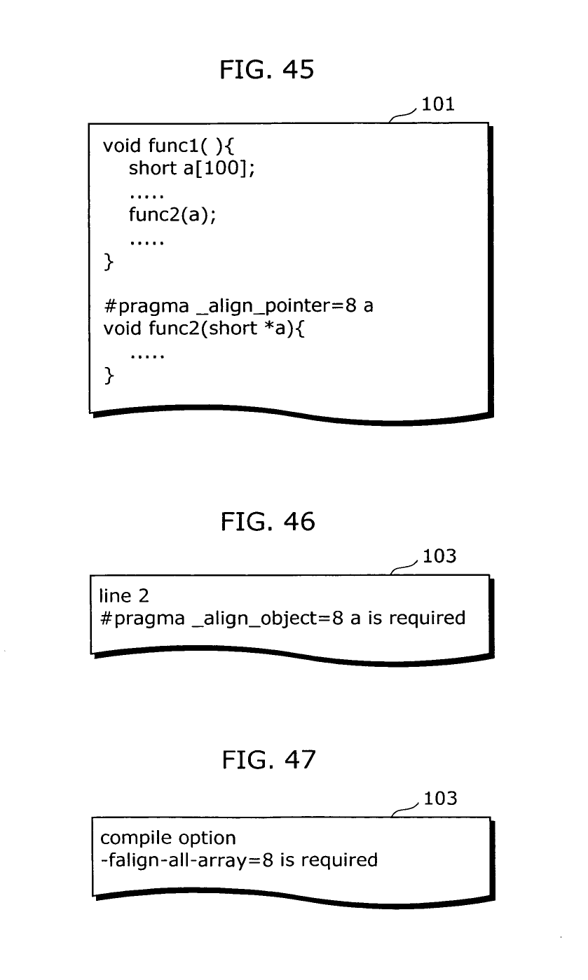

In the case where the program 101 as shown in FIG. 45 is given, each element in the array “a” should be aligned in units of 8 bytes so that the pragma “#pragma_align_pointer=8 a” is not logically contradictory. Therefore, by inserting a pragma “#pragma_align_object=8 a” into line 2 of the program 101, the pragma “#pragma_align_pointer=8 a” will not be logically contradictory. FIG. 46 shows an example of the check result 103 that includes such correction information. Note that such correction information does not need to be given in form of pragma, and may be given in form of compile option. For example, FIG. 47 shows an example of the check result 103 that includes correction information in form of compile option. The “compile option” here is a directive given to the compiler, which specifies a program 101 to be compiled, and can be arbitrarily specified by the user. For example, when the program 101 “foo.c” is compiled, the user can input “cc-falign-all-array=8 foo.c” on a command line of the computer, using a command “cc”.

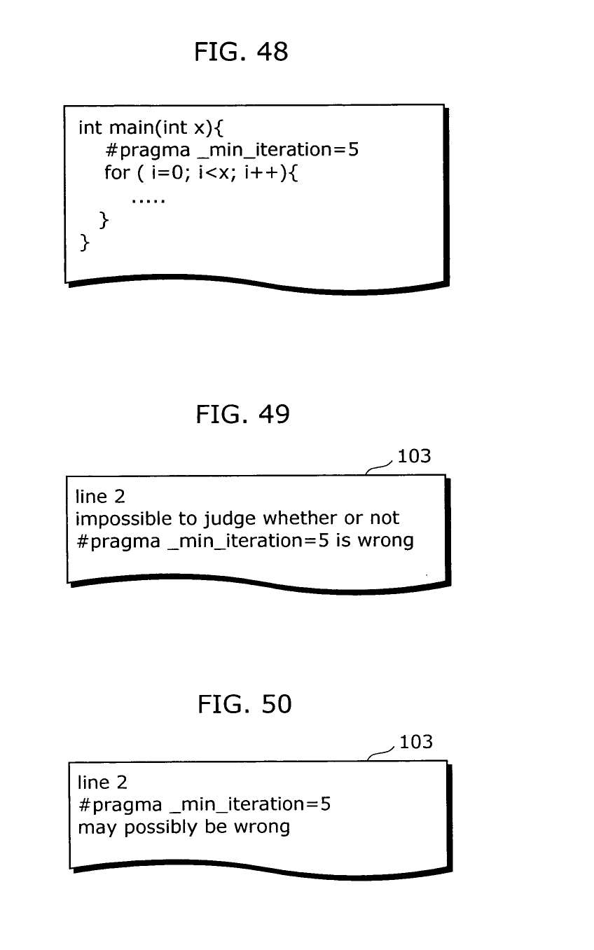

In the case where the program 101 as shown in FIG. 48 is given, a dummy argument “x” in a “main” function, which defines the number of iterations of the for loop, is determined when a machine-language program is executed. Therefore, it is impossible to judge whether or not the pragma “#pragma_min_iteration=5” included in the program 101 is logically contradictory. This is why the check result 103, as shown in FIG. 49, which includes uncertainty information indicating that it is impossible to judge whether or not the pragma is wrong, may be displayed. Also, the check result 103 as shown in FIG. 50, which includes warning information indicating that the pragma is possibly wrong, may be displayed.

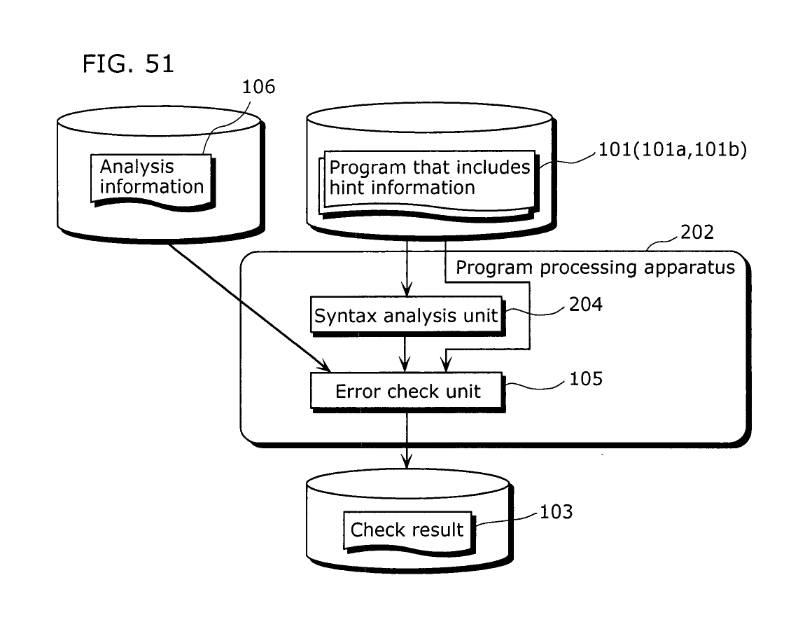

The program processing apparatus 202 as shown in FIG. 51 may be used instead of the program processing apparatus 102 as shown in FIG. 3. The program processing apparatus 202 is an apparatus which receives the program 101 that includes hint information as well as the analysis information 106 created for the program 101, and judges on logical consistency of the hint information in the program 101. Such program processing apparatus 202 includes a syntax analysis unit 204 and the error check unit 105. The syntax analysis unit 204 is a processing unit that receives the program 101 (101a and 101b) and performs normal syntax analysis applied by a compiler or the like, for the program 101 (101a and 101b). Note that the analysis information 106 is a result of the analysis performed on a program 101 (101a and 101b) that is different from a program 101 (101a and 101b) whose syntax is analyzed by the syntax analysis unit 204. For example, in the case where the program 101 is made up of programs 101a and 101b, the analysis information 106 is created for the program 101a, and the program to be inputted into the syntax analysis unit 204 is the program 101b.

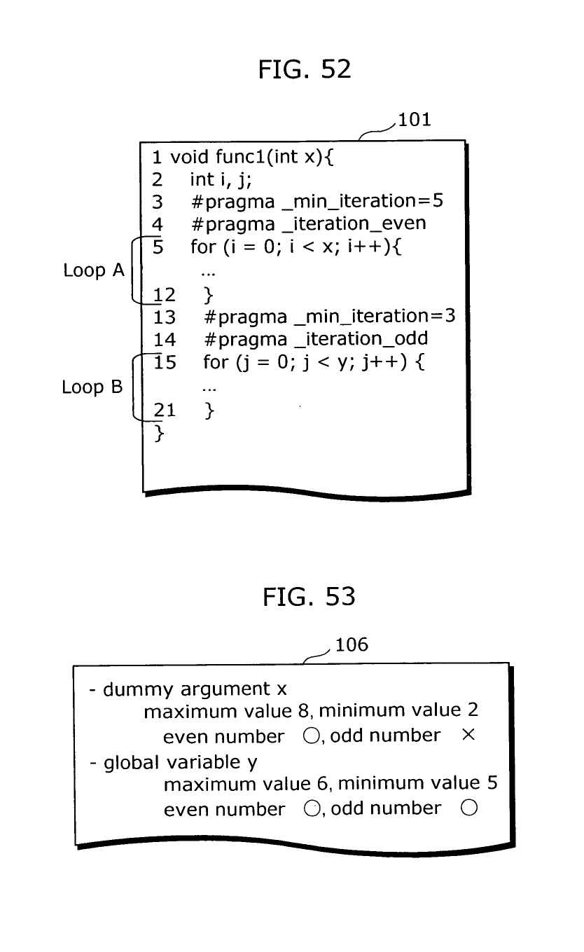

The structure of the error check unit 105 is as same as the one described above, therefore, the detailed description is not repeated here. FIG. 52 shows an example of the program 101 to be inputted into the program processing apparatus 202, while FIG. 53 shows an example of the analysis information 106 to be inputted into the program processing apparatus 202. As a result, the same check result 103 as shown in FIG. 9 can be obtained from the program processing apparatus 202.

It is described that the program 101 is a source program written in the C language, however, the program 101 may be written in a high-level language such as the C++ language, or may be an object program, a program written in an intermediate language, or a program written in an assembly language.

In the above embodiment, a pragma is mainly used as one example of hint information, however, the hint information is not limited to such pragma, and a built-in function, a compiler option or a reserved word written in a programming language may be used instead.

Furthermore, the number of iterations for unrolling executed in loop unrolling is not restricted to two, and it is possible to check the hint information even in the case where the number of iterations is two or greater, by performing the processing based on the same purport.

The number of iterations to be simultaneously executed in software pipelining is not limited to two, and it is possible to check the hint information even in the case where the number of iterations is two or greater, by performing the processing based on the same purport.

Although only some exemplary embodiments of this invention have been described in detail above, those skilled in the art will readily appreciate that many modifications are possible in the exemplary embodiments without materially departing from the novel teachings and advantages of this invention. Accordingly, all such modifications are intended to be included within the scope of this invention.

### INDUSTRIAL APPLICABILITY

The present invention is applicable to a program processing apparatus that checks whether or not the hint information given by the user to a compiler is logically contradictory, and is particularly suitable as a pre-processor that eliminates in advance logical contradiction of the hint information from the program.

What is claimed is:

1. A program processing apparatus,
wherein said apparatus receives a program which includes hint information given by a user to a compiler, and checks if the hint information in the program is logically consistent.

2. The program processing apparatus according to claim 1, comprising:
a syntax analysis unit operable to analyze a syntax of the program which includes the hint information, for generating analysis information; and
a check unit operable to check if the hint information in the program is logically contradictory, based on the analysis information.

3. The program processing apparatus according to claim 2,
wherein the hint information is static information which can be obtained through static analysis of the program, and
said syntax analysis unit is operable to statically analyze the syntax of the program which includes the hint information, for generating the analysis information.

4. The program processing apparatus according to claim 3,
wherein said syntax analysis unit is operable to statically analyze information related to a relationship between functions written in the program which includes the hint information, for generating the analysis information.

5. The program processing apparatus according to claim 3,
wherein the hint information is information related to the number of iterations of loop process, and
said syntax analysis unit is operable to analyze the number of iterations of loop process included in the program which includes the hint information, for generating the analysis information which includes the number of iterations.

6. The program processing apparatus according to claim 5,
wherein the hint information is information which specifies that an iteration of loop process should be performed for a predetermined number of times or more, and
said check unit is operable to check whether or not an iteration of the loop process specified in the hint information is performed for the predetermined number of times or more, based on the analysis information.

7. The program processing apparatus according to claim 5,
wherein the hint information is information which specifies that an iteration of loop process should be performed for a predetermined number of times or less, and
said check unit is operable to check whether or not an iteration of the loop process specified in the hint information is performed for the predetermined number of times or less, based on the analysis information.

8. The program processing apparatus according to claim 5,
wherein the hint information is information which specifies that an iteration of loop process should be performed for N times, where N is always an even number, and
said check unit is operable to check whether or not an iteration of the loop process specified in the hint information is always performed for N times, based on the analysis information.

9. The program processing apparatus according to claim 5,
wherein the hint information is information which specifies that an iteration of loop process should be performed for N times, where N is always an odd number and
said check unit is operable to check whether or not an iteration of the loop process specified in the hint information is always performed for N times, based on the analysis information.

10. The program processing apparatus according to claim 3,
wherein the hint information is information related to a placement of data, and
said syntax analysis unit is operable to analyze the placement of data included in the program which includes the hint information, for generating the analysis information which includes the placement of data.

11. The program processing apparatus according to claim 10,
wherein the hint information is information which specifies data and specifies that the data should be aligned with a predetermined value,
said syntax analysis unit is operable to analyze an alignment value of the data included in the program which includes the hint information, for generating the analysis information which includes a result of the analysis, and
said check unit is operable to check whether or not the alignment value of the data specified in the hint information indicates the predetermined value specified in the hint information, based on the analysis information.

12. The program processing apparatus according to claim 3,
wherein the hint information is information related to an area accessed by a pointer variable, and
said syntax analysis unit is operable to analyze the area accessed by a pointer variable included in the program which includes the hint information, for generating the analysis information which includes a result of the analysis.

13. The program processing apparatus according to claim 12,
wherein the hint information is information which specifies a pointer variable and specifies that the area accessed by the pointer variable should not overlap with an area accessed by another pointer variable,
said syntax analysis unit is operable to analyze whether or not the area accessed by the pointer variable included in the program which includes the hint information overlaps with the area accessed by the another pointer variable, for generating the analysis information which includes a result of the analysis, and
said check unit is operable to check whether or not the area accessed by the pointer variable specified in the hint information overlaps with the area accessed by the another pointer variable, based on the analysis information.

14. The program processing apparatus according to claim 3,
wherein the hint information is information related to reading of data from a variable or writing of data into a variable, and
said syntax analysis unit is operable to analyze reading of data from a variable included in the program which includes the hint information or writing of data into the variable, for generating the analysis information which includes a result of the analysis.

15. The program processing apparatus according to claim 14,
wherein the hint information is information which specifies a variable and specifies, in a position located after a description of the hint information, that an access to the variable should start with writing of data, and
said check unit is operable to check, based on the analysis information, whether or not the access to the variable specified in the hint information starts with writing of data, in a position located after the description of the hint information.

16. The program processing apparatus according to claim 3,
wherein the hint information is information related to a frequency at which a branch condition is satisfied, and
said syntax analysis unit is operable to statically analyze the frequency at which a branch condition is satisfied, the branch condition being included in the program which includes the hint information, for generating the analysis information which includes a result of the analysis.

17. The program processing apparatus according to claim 16,
wherein the hint information is information which indicates that a probability for satisfying a branch condition is high, and
said check unit is operable to check, based on the analysis information, whether or not the probability for satisfying a branch condition is high, the branch condition corresponding to the hint information.

18. The program processing apparatus according to claim 2,
wherein the hint information is information which gives a directive on an optimization method to be applied by a compiler to optimize a program, and
said check unit is operable to check whether or not the optimization method specified in the hint information is feasible, based on the analysis information.

19. The program processing apparatus according to claim 18,
wherein the hint information is information which gives a directive on a loop unrolling optimization of loop process,
said syntax analysis unit is operable to analyze the number of iterations of loop process included in the program which includes the hint information, and to generate the analysis information which includes the number of iterations, and
said check unit is operable to check, based on the analysis information, whether or not the loop unrolling optimization can be performed on the loop process specified in the hint information.

20. The program processing apparatus according to claim 19,
wherein said check unit includes:
a condition judgment unit operable to judge, based on the analysis information, whether or not both of the following conditions are satisfied in the case where the number of iterations of unrolling performed in loop unrolling is two: the number of iterations of the loop process specified in the hint information is two or greater; and the number always indicates either an even number or an odd number; and
a loop unrolling judgment unit operable to judge that the loop unrolling optimization can be performed on the loop process specified in the hint information, in the case where the conditions are satisfied.

21. The program processing apparatus according to claim 18,
wherein the hint information is information which gives a directive on a software pipelining optimization of loop process,
said syntax analysis unit is operable to analyze the number of iterations of loop process included in the program which includes the hint information, and to generate the analysis information which includes a result of the analysis, and
said check unit is operable to check, based on the analysis information, whether or not the software pipelining optimization can be performed on the loop process included/specified in the hint information.

22. The program processing apparatus according to claim 21,
wherein said check unit includes:
an iteration number judgment unit operable to judge, based on the analysis information, whether or not the number of iterations of the loop process specified in the hint information is n that is an integer of 2 or greater, in the case where the number of iterations to be simultaneously executed is n or greater; and
a software pipelining judgment unit operable to judge that the software pipelining optimization can be performed on the loop process specified in the hint information, in the case where the number of iterations of the loop process is n or greater.

23. The program processing apparatus according to claim 18,
wherein the hint information is information which specifies plural data and gives a directive on an optimization of data access based on a generation of a pair instruction for the plural data,
said syntax analysis unit is operable to analyze an alignment value of the data included in the program which includes the hint information, for generating the analysis information which includes a result of the analysis, and
said check unit includes:
a condition judgment unit operable to judge, based on the analysis information, whether or not an alignment value of the plural data specified in the hint information satisfies a condition that the alignment value indicates a size two or more times larger than a size of a data type of the plural data; and
a pair instruction generation judgment unit operable to judge that the optimization of data access based on the generation of a pair instruction can be performed on the plural data specified in the hint information, in the case where the condition is satisfied.

24. The program processing apparatus according to claim 18,
wherein the hint information is information which specifies a variable and gives a directive on an optimization of control processing to be performed on a cache memory.

25. The program processing apparatus according to claim 24,
wherein the hint information is information which specifies a variable and instructs that an area for storing a value of the variable should be allocated in the cache memory, and
said check unit includes:
a condition judgment unit operable to judge whether or not the variable specified in the hint information satisfies the following condition: an access to the variable starts with writing of data in a position located after a description of the hint information; and
a cache memory optimization judgment unit operable to judge that an optimization of the cache memory can be performed by allocating an area, in the cache memory, for storing a value of the variable specified in the hint information, in the case where the condition is satisfied.

26. The program processing apparatus according to claim 2, further comprising
an error information output unit operable to output error information in the case where said check unit judges that the hint information is logically consistent.

27. The program processing apparatus according to claim 26,
wherein said error information output unit is operable to output a method of correcting the hint information, in the case where said check unit judges that the hint information is logically consistent.

28. The program processing apparatus according to claim 26,
wherein said error information output unit is operable to output missing hint information in the case where said check unit judges that the hint information is logically consistent.

29. The processing apparatus according to claim 26,
wherein said error information output unit is operable to output, when the compiler is activated, a compile option specified by the user for the program which includes the hint information to be compiled, in the case where said check unit judges that the hint information is logically consistent.

30. The program processing apparatus according to claim 2, further comprising
an error information output unit operable to output error information indicating that it is impossible to judge whether or not the hint information is logically consistent, in the case where said check unit is not able to judge whether or not the hint information is logically consistent.

31. The program processing apparatus according to claim 1,
wherein the program is written in the C language or the C++ language, and
the hint information is a pragma description which is a directive describable in the program by the user, the directive being given to the compiler.
